(19) United States
(12) Patent Application Publication
(10) Pub. No.: US 2026/0192881 A1
(43) Pub. Date: Jul. 9, 2026

(54) CONTINUOUSLY VARIABLE TRANSMISSION FOR A BICYCLE

(71) Applicant: GATES CORPORATION, Denver, CO (US)

(72) Inventors: Patricio De La Torre, Auburn Hills, MI (US); Andrzej Dec, Nowa Deba (PL); Minchun Hao, Troy, MI (US); David P. Rieland, Troy, MI (US); Marc Cadarette, Windsor (CA)

(73) Assignee: GATES CORPORATION, Denver, CO (US)

(21) Appl. No.: 19/125,865

(22) PCT Filed: Oct. 31, 2023
(86) PCT No.: PCT/US2023/078279

§ 371 Date: Apr. 30, 2025

Related U.S. Application Data
(60) Provisional application No. 63/421,031, filed on Oct. 31, 2022.

(51) Int. Cl. B62M 9/06; B62M 11/14; B62M 25/08

(52) U.S. Cl. CPC B62M 9/06; B62M 11/14; B62M 25/08

(57) ABSTRACT

A continuously variable transmission for a bicycle is provided that improves the functionality of the bicycle and increases the reliability and longevity of the transmission. The transmission is continuously variable among a potentially infinite number of speed ratios allowing a user to select the proper speed ratio based on the operating conditions, the motion of the bicycle, and any other considerations from the user. A driver assembly reduces the torque from a crankshaft to a set of sheaves and a belt to improve the reliability and longevity of the components of the transmission that set the speed ratio. Moreover, a position motor simply and precisely controls the speed ratio by controlling the relative positioning between sheaves. A driven assembly increases torque for output to a drive wheel, which propels the bicycle.

### CROSS-REFERENCE TO RELATED APPLICATIONS

This application claims priority to U.S. Provisional Patent Application Ser. No. 63/421,031 filed Oct. 31, 2022, which is incorporated herein in its entirety by reference.

### FIELD OF THE INVENTION

The disclosure relates to a continuously variable transmission, in particular for a bicycle, that transmits power from a crankshaft to a rear hub through a potentially infinite number of speed ratios.

### BACKGROUND OF THE INVENTION

Some prior art bicycles have a chain linking a single sprocket at a crankshaft and a single sprocket at a rear hub to transmit power from the pedaling motion of the rider at the crankshaft to the rear wheel at the rear hub, which propels the bicycle. However, with one sprocket at the crankshaft and one sprocket at the rear hub, the bicycle has only a single gear ratio to transmit power to the rear wheel at the rear hub. This gear ratio can be optimized for a narrow range of operating conditions of the bicycle, but not multiple ranges of operating conditions. For instance, the gear ratio can be a high gear ratio where the sprocket at the rear hub has relatively more teeth, which provides increased torque for moving a bicycle from a rest position but will limit the ability of the rider to achieve high speeds on the bicycle. Conversely, the gear ratio can be a low gear ratio where the sprocket at the rear hub has relatively fewer teeth, allows for increased speed but will limit the ability of the user to initially propel the bicycle from a rest position.

To address this issue, other prior art bicycles have multiple sprockets at the crankshaft and/or multiple sprockets at the rear hub to provide multiple possible gear ratios between the crankshaft and the rear hub. Thus, a rider can start with a high gear ratio when the bicycle is at rest to provide more torque and help propel the bicycle from a rest position. Then, a derailleur can move the chain linking the crankshaft and the rear hub from a sprocket, at either the crankshaft or the rear hub, to another sprocket to establish a low gear ratio. As a result, the rider can further increase the speed of the bicycle, much like a conventional automobile cycling through gears as the automobile increases speed. However, even with multiple gears, the rider has only a few, finite number of gear ratios to select from. These few gear ratios are optimized only for certain operating conditions that may not apply to a particular rider. Moreover, multiple sprockets, derailleurs, and other shifting components add complexity, weight, and more potential points of failure to the bicycle.

Another prior art system includes multiple spur or helical gears located at the crankshaft. The system of gears operates like the transmission of an automobile and requires a complex shifter to change among the gear ratios. Like the sprockets and derailleur described above, this system of gears allows a user to change between a few, finite number of gear ratios, and these systems are complex, heavy, and expensive.

In contrast to the system of sprockets and derailleur as well as the system of gears at the crankshaft, embodiments of the present disclosure do not rely on sprockets or gears for a few, finite number of gear ratios. Instead, embodiments described herein have sets of sheaves joined by a belt that continuously moves among a potentially infinite number of speed ratios, which allows a user to specifically choose the proper speed ratio for the current operating conditions. A “speed ratio” describes the relative mechanical advantage between sets of sheaves and is akin to a gear ratio.

Other prior art systems that transmit power can be located at the rear hub of a bicycle. One such system has planetary gears inside the rear hub that rely on a delicate shifter to change gear ratios, and the shifter requires the bicycle to be in motion and coasting without input power in order to change gear ratios. As described herein, embodiments of the present disclosure have a position motor that precisely controls the speed ratio. Moreover, the position motor can control the speed ratio and hold a particular speed ratio during operation.

Another prior art system located at the rear hub uses a continuously variable mechanism with a rotating ring of balls to continuously change the gear ratio, or speed ratio, between an input and an output of the system. However, this system requires a special traction fluid, has high internal forces that reduce reliability and longevity of the system, and is heavy, inefficient, and expensive. Embodiments of the present disclosure provide a continuously variable transmission that does not require a special fluid and that reduces internal forces to improve the reliability and longevity of the transmission. Specifically, a drive assembly described herein increases the rotational speed of the sheaves and the belt to reduce the torque experienced by these components, which reduces wear and tear and increases the reliability and longevity of the transmission.

### SUMMARY OF THE INVENTION

Embodiments of the present disclosure relate to a novel transmission that allows for the continuous change of a speed ratio between an input crankshaft and an output drive wheel among a potentially infinite number of speed ratios. Moreover, embodiments of the present disclosure more precisely control the speed ratio and are more reliable and longer lasting. Many embodiments described herein relate to a transmission for a bicycle, but the transmission according to the present disclosure can be applied to any small manpowered vehicle or electric vehicle with a transmission.

It is one aspect of various embodiments of the present disclosure to provide a continuously variable transmission that has sets of sheaves and a belt to provide the stepless change among a potentially infinite number of speed ratios, which allows a user to control the speed ratio for the particular operating conditions of the bicycle. One set of sheaves is positioned around the crankshaft that is rotatable about a crank axis, and another set of sheaves is positioned around a countershaft that is rotatable about a counter axis, which is parallel to the crank axis. Power is transmitted from the set of sheaves around the crankshaft, or the driver sheaves, to the set of sheaves around the countershaft, or the driven sheaves, via the belt. Each set of sheaves has a fixed sheave that rotates about the shaft but does not move along the shaft, and each set of sheaves has a moveable sheave that rotates about the shaft and moves along the shaft.

To change the speed ratio between the sets of sheaves and for the entire transmission, one of the moveable sheaves changes position along its respective shaft. For example, if the moveable driven sheave is closer to the fixed driven sheave, the belt moves to contact the inner surfaces of the driven sheaves farther away from the counter axis. The moveable driver sheave moves to accommodate the change of position of the belt, and this establishes a high speed ratio. Conversely, if the moveable driven sheave is further from the fixed driven sheave, the belt moves and contacts the inner surfaces of the driven sheaves closer to the counter axis. Again, the moveable driver sheave moves to accommodate the change of position of the belt, and this establishes a low speed ratio. A bias member acting on the moveable driver sheave accommodates these changes in speed ratio as described in further detail herein.

It is an aspect of embodiments of the present disclosure to provide a position motor to simply and precisely control the position of the moveable driven sheave along the counter axis to establish a speed ratio of the transmission. The position motor can be, for instance, a servo motor with an output shaft that is rotatable about an axis. In various embodiments, an eccentric cam is connected to the output shaft, and a hub is connected to the moveable driven sheave. The eccentric cam is positioned in a recess of the hub such that when the output shaft and eccentric cam rotate, the hub and the moveable driven sheave move along the counter axis to establish the speed ratio. Consequently, the position motor can change the speed ratio and hold a desired speed ratio through a range of bicycle speeds and input powers. In addition, the position motor can change the speed ratio while the bicycle is at rest or in motion and/or while the user is pedaling to provide power to the transmission, or simply coasting.

It is a further aspect of some embodiments of the present disclosure to reduce the torque acting on the sheaves and belt to increase the reliability and longevity of the transmission. In general, force or torque is inversely related to speed in transmissions where an increase in torque is associated with a decrease in speed, and a decrease in torque is associated with an increase in speed. High torque on the sheaves and the belt will reduce the life of these components. In addition, high torque on the sheaves can damage the position motor or other components. Thus, speed is increased to reduce the torque at the sheaves and belt. A driver assembly transmits torque from the crankshaft to the driver sheaves, and the driver assembly increases the rotational speed of the sheaves compared to the crankshaft while reducing the torque, which increases the reliability and longevity of the transmission.

The driver assembly can be arranged to accommodate various constraints of a bicycle. For example, embodiments of the transmission may be located at the bottom bracket of a bicycle frame where the user engages the pedals and crankshaft, and some components of the transmission are positioned about the crankshaft. Accordingly, some components of the transmission are constrained by certain dimensions such as the distance between crank arms that join the pedals to the crankshaft and a clearance distance of the bottom bracket above the ground surface. Therefore, in various embodiments, the driver assembly comprises two planetary gear sets connected in series to transmit power from the crankshaft to the driver sheaves. In these embodiments, the driver assembly can be referred to as a driver gear assembly. The use of two planetary gear sets meets the necessary torque reduction while keeping the form factor of the transmission sufficiently compact. However, it will be appreciated that the present disclosure encompasses embodiments of the transmission for a bicycle that have more or fewer sets of gears or other components such as sprockets and belts, and the present disclosure encompasses embodiments of the transmission for other vehicles subject to other practical constraints.

It is yet another aspect of embodiments of the present disclosure to provide a driven assembly and output gears to transmit power from the driven sheaves and the countershaft to the drive wheel, which in turn powers the rear wheel and propels the vehicle. The rotation speed of the sheaves and belt are increased to reduce torque within the transmission, yet now the torque needs to be increased to be useful for the drive wheel and to propel the vehicle. A driven assembly is positioned around the countershaft and engaged with the countershaft. The driven assembly can be one or more planetary gear sets that reduces speed and increases torque. In these embodiments, the driven assembly is a driven gear assembly. Then, in some embodiments, the output of the driven gear assembly is engaged with a first output gear positioned around the countershaft. Another, second output gear is positioned around the crankshaft and engaged with the first output gear. Finally, in various embodiments, the second output gear transmits power to the drive wheel to propel the bicycle. It will be appreciated that in some embodiments a belt transmits power from the driven assembly to the drive wheel, or that the driven assembly comprises components such as sprockets, belts, etc.

A further aspect of embodiments of the present disclosure is to provide a controller to coordinate and operate the various components of the transmission, in particular, the position motor. In some embodiments, the transmission includes a battery in communication with the controller to power the position motor and includes a generator engaged with a rotating component of the transmission to transmit electrical power to the battery. Based on one or more input signals, the controller can dictate the amount of electric power transmitted to the position motor. Further, the controller can transmit an output signal to the position motor to control various aspects of the position motor such as the speed or acceleration of an output shaft, the direction of rotation of the output shaft, etc.

A variety of devices can transmit the one or more input signals to the controller, for example to change the speed ratio of the transmission. For instance, a shifter on the handlebars of the bicycle can transmit an input signal to the controller. A user displaces a dial or paddle, and a position sensor detects the displacement and transmits an input signal to the controller. Similarly, a torque sensor can detect a torque that a user applies to a crankshaft and transmit an input signal to the controller. The controller can process the one or more input signals to then dictate the flow of electrical power to the position motor as well as any output signal to the position motor to set the proper speed ratio of the transmission.

It is an aspect of embodiments of the present disclosure to provide a continuously variable transmission that has a set of driver sheaves positioned about a countershaft and a set of driven sheaves positioned about a crankshaft. A driver assembly transmits power from the crankshaft to the countershaft, and the countershaft transmits power to the driver sheaves. Then, the driver sheaves transmit power to the driven sheaves via a belt, and the driven sheaves transmit power to a drive wheel via, for instance, a driven assembly. With this arrangement and with a position motor positioned adjacent to the moveable driver sheave, the number and complexity of parts is reduced. The position motor controls the speed ratio of the transmission by controlling the position of the moveable driver sheave, and as a result, the transmission is more responsive to inputs from the user or otherwise and changes speed ratios faster.

In embodiments where the driver sheaves are positioned about the countershaft, and other embodiments, the driver assembly and the driven assembly can comprise multiple gears, sprockets, belts, etc. to transmit power. In some embodiments, the driver assembly comprises a first gear positioned about a crankshaft, a second gear positioned about an intermediate shaft and intermeshed with the first gear, a third gear positioned about the intermediate shaft, and a fourth gear positioned about a countershaft and intermeshed with the third gear. Thus, power is transmitted from the crankshaft to the first gear, which drives the second gear and the intermediate shaft. Then, the intermediate shaft transmits power to the third gear, the fourth gear, and the countershaft. The gears are sized and arranged such that the countershaft rotates faster and with less torque compared to the crankshaft, which reduces wear and tear on components of the transmission.

Similarly, the driven assembly can comprise multiple gears, sprockets, belts, etc. to transmit power. In some embodiments, the driven assembly comprises a sun gear that receives power from the driven sheaves, planetary gears, a carrier connected to the planetary gears, and a ring gear. The carrier serves as an output of the driven assembly and transmits power to a drive wheel such that the drive wheel rotates slower and with more torque compared to the driven sheaves. In other embodiments, the driven assembly can span between the countershaft and the crankshaft where a first sprocket is positioned about the countershaft, a second sprocket is positioned about the crankshaft, and a synchronous belt links the sprockets. Power is transmitted from the countershaft to the first sprocket, to the belt, and to the second sprocket, which can then transmit power to a drive wheel such that the drive wheel rotates slower and with more torque compared to the countershaft.

A first aspect of the present disclosure is to provide a continuously variable transmission for a bicycle, comprising a crankshaft rotatable about a crank axis; a driver gear assembly positioned about the crankshaft, wherein an input of the driver gear assembly is engaged with the crankshaft, and wherein an output of the driver gear assembly is configured to rotate faster and with less torque than the crankshaft; a set of driven sheaves positioned about the crankshaft and engaged with the output of the driver gear assembly; a countershaft rotatable about a counter axis; a set of driver sheaves positioned about the countershaft and engaged with the countershaft; a belt joining the set of driver sheaves and the set of driven sheaves and configured to transmit power from the set of driver sheaves to the set of driven sheaves, wherein a speed ratio between the sets of driver and driven sheaves is continuously variable; and a driven gear assembly positioned about the countershaft, wherein an input of the driven gear assembly is engaged with the countershaft, wherein an output of the driven gear assembly is configured to rotate slower and with more torque than the countershaft, and wherein the output of the driven gear assembly is configured to transmit power to a drive wheel to propel the bicycle.

The transmission of the first aspect may include, optionally, a position motor, wherein the set of driven sheaves comprises a fixed sheave; and a moveable sheave engaged with the position motor, wherein the position motor is configured to move the moveable sheave along the counter axis to change the speed ratio between the sets of driver and driven sheaves.

The transmission of the first aspect may include one or more of the previous embodiments and, optionally, a bias member, wherein the set of driver sheaves comprises a fixed sheave; and a moveable sheave, wherein the bias member is configured to act on the moveable sheave along the crank axis, and wherein the moveable sheave is configured to change position along the crank axis to accommodate the speed ratio established by the set of driven sheaves.

The transmission of the first aspect may include one or more of the previous embodiments and, optionally, that the driver gear assembly comprises a first planetary gear set having a ring gear, a plurality of first planetary gears, a first carrier, and a first sun gear, wherein the first carrier is the input for the driver gear assembly, and the first carrier is configured to drive the plurality of first planetary gears between the ring gear and the first sun gear to rotate the first sun gear faster and with less torque than the crankshaft; and a second planetary gear set having a plurality of second planetary gears, a second carrier, and a second sun gear, wherein the second carrier is engaged with the first sun gear, and the second carrier is configured to drive the plurality of second planetary gears between the ring gear and the second sun gear to rotate the second sun gear faster and with less torque than the first sun gear, and wherein the second sun gear is the output of the driver gear assembly.

The transmission of the first aspect may include one or more of the previous embodiments and, optionally, that the first planetary gear set has a gear ratio, and the second planetary gear set has the gear ratio, and wherein the gear ratio is between approximately 1:3.5 and 1:4.5.

The transmission of the first aspect may include one or more of the previous embodiments and, optionally, that the driven gear assembly comprises a planetary gear set having a ring gear, a plurality of planetary gears, and a sun gear, wherein the sun gear is the input for the driven gear assembly, wherein the sun gear is configured to drive the plurality of planetary gears, wherein the plurality of planetary gears is configured to drive the ring gear slower and with more torque than the sun gear, and wherein the ring gear is the output of the driven gear assembly.

The transmission of the first aspect may include one or more of the previous embodiments and, optionally, a drive wheel positioned about the crankshaft; and an output gear positioned about the crankshaft and engaged with the drive wheel, wherein teeth extending around an outer surface of the ring gear are configured to transmit power to the output gear, and wherein the output gear is configured to transmit power to the drive wheel to propel the bicycle.

A second aspect of the present disclosure is to provide a continuously variable transmission system for a bicycle, comprising a crankshaft rotatable about a crank axis; a fixed driver sheave and a moveable driver sheave positioned about the crankshaft, wherein the fixed and moveable driver sheaves are configured to receive power from the crankshaft; a countershaft rotatable about a counter axis; a fixed driven sheave and a moveable driven sheave positioned about the countershaft; a belt joining the fixed and moveable driver sheaves to the fixed and moveable driven sheaves, wherein the belt is configured to transmit power from the fixed and moveable driver sheaves to the fixed and moveable driven sheaves, and wherein a speed ratio between the fixed and moveable driver sheaves and the fixed and moveable driven sheaves is continuously variable; a bias member configured to act on the moveable driver sheave along the crank axis, wherein the moveable driver sheave changes position along the crank axis to accommodate the speed ratio established by the fixed and moveable driven sheaves; and a position motor engaged with the moveable driven sheave, wherein the position motor is configured to move the moveable driven sheave along the counter axis to change the speed ratio between the fixed and moveable driver sheaves and the fixed and moveable driven sheaves.

The transmission of the second aspect may include, optionally, that the position motor is a servo motor with an output shaft, and wherein rotation of the output shaft causes the moveable driven sheave to move along the counter axis.

The transmission of the second aspect may include one or more of the previous embodiments and, optionally, an eccentric cam connected to the output shaft of the servo motor; and a hub connected to the moveable driven sheave, wherein the eccentric cam extends into a recess of the hub, and rotation of the output shaft and rotates the eccentric cam and causes the hub and the moveable driven sheave to move along the counter axis, which changes the speed ratio between the fixed and moveable driver sheaves and the fixed and moveable driven sheaves.

The transmission of the second aspect may include one or more of the previous embodiments and, optionally, a controller in communication with the position motor; and a shifter in communication with the controller, wherein the shifter is configured to transmit an input signal to the controller, and the controller is configured to cause the position motor to move the moveable driven sheave along the counter axis to change the speed ratio between the fixed and moveable driver sheaves and the fixed and moveable driven sheaves.

The transmission of the second aspect may include one or more of the previous embodiments and, optionally, a controller in communication with the position motor; and a torque sensor operably engaged with the crankshaft and in communication with the controller, wherein the torque sensor is configured to transmit an input signal to the controller, and the controller is configured to cause the position motor to move the moveable driven sheave along the counter axis to change the speed ratio between the fixed and moveable driver sheaves and the fixed and moveable driven sheaves.

The transmission of the second aspect may include one or more of the previous embodiments and, optionally, a plurality of pins extending from the countershaft; and a plurality of slots extending through a portion of the moveable driven sheave, and wherein the plurality of pins is positioned in the respective plurality of slots such that the moveable driven sheave is moveable relative to the countershaft along the counter axis.

The transmission of the second aspect may include one or more of the previous embodiments and, optionally, that each slot of the plurality of slots extends along a line that is nonparallel with the counter axis.

The transmission of the second aspect may include one or more of the previous embodiments and, optionally, that portion of the moveable driven sheave with the slots may be a cylindrical portion and/or a portion positioned around the countershaft.

The transmission of the second aspect may include one or more of the previous embodiments and, optionally, that the portion of the moveable driven sheave with the slots is a portion that does not contact the belt.

A third aspect of the present disclosure is to provide a continuously variable transmission for a bicycle, comprising a housing extending from a first side to a second side; a fixed driver sheave and a moveable driver sheave rotatable about a crank axis, wherein the moveable driver sheave is positioned between the first side of the housing and the fixed driver sheave; a countershaft at least partially positioned within the housing and rotatable about a counter axis; a fixed driven sheave and a moveable driven sheave positioned about the countershaft, wherein the fixed driven sheave is positioned between the first side of the housing and the moveable driven sheave; a plurality of pins extending from the countershaft; a plurality of slots extending through the moveable driven sheave, wherein the plurality of pins is positioned in the respective plurality of slots such that the moveable driven sheave is moveable relative to the countershaft along the counter axis; and a belt joining the two driver sheaves and the two driven sheaves, wherein the belt is configured to transmit power from the two driver sheaves to the two driven sheaves, wherein a speed ratio between the two driver sheaves and the two driven sheaves is continuously variable, and wherein power is configured to be transmitted to the countershaft to propel the bicycle.

The transmission of the third aspect may include, optionally, that the portion of the moveable driven sheave with the slots may be a cylindrical portion and/or a portion positioned around the countershaft.

The transmission of the third aspect may include one or more of the previous embodiments and, optionally, that the portion of the moveable driven sheave with the slots is a portion that does not contact the belt.

The transmission of the third aspect may include one or more of the previous embodiments and, optionally, a position motor engaged with the moveable driven sheave, wherein the position motor is configured to move the moveable driven sheave along the counter axis to change the speed ratio between the two driver sheaves and the two driven sheaves; and a bias member configured to act on the moveable driver sheave along the crank axis, wherein the moveable driver sheave is configured to change position along the crank axis to accommodate the speed ratio established by the two driven sheaves.

The transmission of the third aspect may include one or more of the previous embodiments and, optionally, a driver gear assembly positioned between the first side of the housing and the moveable driver sheave, wherein an input of the driver gear assembly is configured to receive power from a crankshaft, an output of the driver gear assembly is configured to rotate faster and with less torque than the crankshaft, and the two driver sheaves are engaged with the output of the driver gear assembly.

The transmission of the third aspect may include one or more of the previous embodiments and, optionally, a driven gear assembly positioned about the countershaft between the first side of the housing and the fixed driven sheave, wherein an input of the driven gear assembly is engaged with the countershaft, and an output of the driven gear assembly is configured to rotate slower and with more torque than the countershaft.

The transmission of the third aspect may include one or more of the previous embodiments and, optionally, that the driver gear assembly and the driven gear assembly are positioned in a sealed portion of the housing that is at least partially filled with lubricant.

The transmission of the third aspect may include one or more of the previous embodiments and, optionally, that the belt has a v-shaped cross-section, and inner surfaces of the two driver sheaves and the inner surfaces of the two driven sheaves are tapered to complement the side surfaces of the v-shaped belt.

A fourth aspect of the present disclosure is to provide a continuously variable transmission for a bicycle, comprising a crankshaft rotatable about a crank axis; a countershaft rotatable about a counter axis; a driver assembly having an input engaged with the crankshaft and an output engaged with the countershaft, wherein the crankshaft drives the driver assembly, and the driver assembly drives the countershaft such that the countershaft rotates faster and with less torque than the crankshaft; a set of driver sheaves positioned about the countershaft and engaged with the countershaft; a set of driven sheaves positioned about the crankshaft; a belt joining the set of driver sheaves and the set of driven sheaves and configured to transmit power from the set of driver sheaves to the set of driven sheaves, wherein a speed ratio between the sets of driver and driven sheaves is continuously variable; and a driven assembly positioned about the crankshaft, wherein an input of the driven assembly is engaged with the set of driven sheaves, wherein an output of the driven assembly is configured to rotate slower and with more torque than the set of driven sheaves, and wherein the output of the driven assembly is configured to transmit power to propel the bicycle.

The transmission of the fourth aspect may include, optionally, a position motor, wherein the set of driver sheaves comprises a fixed sheave; and a moveable sheave engaged with the position motor, wherein the position motor is configured to move the moveable sheave along the counter axis to change the speed ratio between the sets of driver and driven sheaves.

The transmission of the fourth aspect may include one or more of the previous embodiments and, optionally, a bias member, wherein the set of driven sheaves comprises a fixed sheave; and a moveable sheave, wherein the bias member is configured to act on the moveable sheave along the crank axis, and wherein the moveable sheave is configured to change position along the crank axis to accommodate the speed ratio established by the set of driver sheaves.

The transmission of the fourth aspect may include one or more of the previous embodiments and, optionally, that the driver assembly comprises a first gear positioned about the crankshaft and that is the input of the driver assembly, and a second gear positioned about and engaged with an intermediate shaft, wherein crankshaft drives the first gear, and the first gear drives the second gear such that the intermediate shaft rotates faster and with less torque than the crankshaft; and a third gear positioned about and engaged with the intermediate shaft, and a fourth gear positioned about the countershaft and that is the output of the driver assembly, wherein the intermediate shaft drives the third gear, and the third gear drives the fourth gear such that the countershaft rotates faster and with less torque than the intermediate shaft.

The transmission of the fourth aspect may include one or more of the previous embodiments and, optionally, that a gear ratio between the input and output of the driver assembly is between approximately 1:3.8 to 1:14.5.

The transmission of the fourth aspect may include one or more of the previous embodiments and, optionally, that the driven assembly comprises a planetary gear set having a ring gear, a plurality of planetary gears, a carrier joining the plurality of planetary gears, and a sun gear, wherein the sun gear is the input for the driven assembly, wherein the sun gear is configured to drive the plurality of planetary gears against the ring gear such that the carrier turns slower and with more torque than the sun gear, and wherein the carrier is the output of the driven assembly.

The transmission of the fourth aspect may include one or more of the previous embodiments and, optionally, that the driven assembly comprises a first sprocket that is the input of the driven assembly, and a second sprocket that is the output of the driven assembly; and a belt joining the first sprocket and the second sprocket.

A fifth aspect of the present disclosure is to provide a continuously variable transmission system for a bicycle, comprising a crankshaft rotatable about a crank axis; a countershaft rotatable about a counter axis; a fixed driver sheave and a moveable driver sheave positioned about the countershaft, wherein the fixed and moveable driver sheaves are configured to receive power from the countershaft; a fixed driven sheave and a moveable driven sheave positioned about the crankshaft; a belt joining the fixed and moveable driver sheaves to the fixed and moveable driven sheaves, wherein the belt is configured to transmit power from the fixed and moveable driver sheaves to the fixed and moveable driven sheaves, and wherein a speed ratio between the fixed and moveable driver sheaves and the fixed and moveable driven sheaves is continuously variable; a bias member configured to act on the moveable driven sheave along the crank axis, wherein the moveable driven sheave changes position along the crank axis to accommodate the speed ratio established by the fixed and moveable driver sheaves; and a position motor engaged with the moveable driver sheave, wherein the position motor is configured to move the moveable driver sheave along the counter axis to change the speed ratio between the fixed and moveable driver sheaves and the fixed and moveable driven sheaves.

The transmission of the fifth aspect may include, optionally, that the position motor is a servo motor with an output shaft, and wherein rotation of the output shaft causes the moveable driver sheave to move along the counter axis.

The transmission of the fifth aspect may include one or more of the previous embodiments and, optionally, an eccentric cam connected to the output shaft of the servo motor; and a hub configured to move along the counter axis, wherein the eccentric cam extends into a recess of the hub, and rotation of the output shaft and rotates the eccentric cam and causes the hub to move the moveable driver sheave along the counter axis, which changes the speed ratio between the fixed and moveable driver sheaves and the fixed and moveable driven sheaves.

The transmission of the fifth aspect may include one or more of the previous embodiments and, optionally, a controller in communication with the position motor; and a shifter in communication with the controller, wherein the shifter is configured to transmit an input signal to the controller, and the controller is configured to cause the position motor to move the moveable driver sheave along the counter axis to change the speed ratio between the fixed and moveable driver sheaves and the fixed and moveable driven sheaves.

The transmission of the fifth aspect may include one or more of the previous embodiments and, optionally, a controller in communication with the position motor; and a torque sensor operably engaged with the crankshaft and in communication with the controller, wherein the torque sensor is configured to transmit an input signal to the controller, and the controller is configured to cause the position motor to move the moveable driver sheave along the counter axis to change the speed ratio between the fixed and moveable driver sheaves and the fixed and moveable driven sheaves.

The transmission of the fifth aspect may include one or more of the previous embodiments and, optionally, a driver assembly having an input engaged with the crankshaft and an output engaged with the countershaft, wherein the crankshaft drives the driver assembly, and the driver assembly drives the countershaft such that the countershaft rotates faster and with less torque than the crankshaft; and a driven assembly positioned about the crankshaft, wherein an input of the driven assembly is engaged with the fixed and moveable driven sheaves, wherein an output of the driven assembly is configured to rotate slower and with more torque than the fixed and moveable driven sheaves, and wherein the output of the driven assembly is configured to transmit power to propel the bicycle.

The transmission of the fifth aspect may include one or more of the previous embodiments and, optionally, that the bias member is a spring producing one of a linearly changing force or a non-linearly changing force in response to displacement.

A sixth aspect of the present disclosure is to provide a continuously variable transmission for a bicycle, comprising a housing extending from a first side to a second side; a crankshaft rotatable about a crank axis, wherein the crankshaft is at least partially positioned in the housing; a countershaft rotatable about a counter axis, wherein the countershaft is positioned in the housing; a fixed driver sheave and a moveable driver sheave positioned about the countershaft, wherein the fixed and moveable driver sheaves are positioned in the housing, and the moveable driver sheave is positioned between the fixed driver sheave and the first side of the housing, wherein the fixed and moveable driver sheaves are configured to receive power from the countershaft; a fixed driven sheave and a moveable driven sheave positioned about the crankshaft, wherein the fixed and moveable driven sheaves are positioned in the housing, and the moveable driven sheave is positioned between the fixed driven sheave and the second side of the housing; a belt configured to transmit power from the fixed and moveable driver sheaves to the fixed and moveable driven sheaves, and wherein a speed ratio between the fixed and moveable driver sheaves and the fixed and moveable driven sheaves is continuously variable; and a position motor positioned between the moveable driver sheave and the first side of the housing, wherein the position motor is configured to move the moveable driver sheave along the counter axis to change the speed ratio between the fixed and moveable driver sheaves and the fixed and moveable driven sheaves.

The transmission of the sixth aspect may include, optionally, a bias member configured to act on the moveable driven sheave along the crank axis, wherein the bias member is positioned between the moveable driven sheave and the second side of the housing, and the moveable driven sheave changes position along the crank axis to accommodate the speed ratio established by the fixed and moveable driver sheaves.

The transmission of the sixth aspect may include one or more of the previous embodiments and, optionally, a fixed collar positioned about the crankshaft, wherein the fixed driven sheave is engaged with the fixed collar; a moveable collar positioned about the fixed collar, wherein the moveable driven sheave is engaged with a moveable collar; a plurality of pins extending from the fixed collar into respective slots of the moveable collar such that the moveable collar and the moveable driven sheave are configured to transmit power to the fixed collar and to move along the crank axis.

The transmission of the sixth aspect may include one or more of the previous embodiments and, optionally, a driver assembly positioned between the second side of the housing and the fixed driver sheave, wherein the driver assembly is configured to transmit power from the crankshaft to the countershaft such that the countershaft rotates faster and with less torque than the crankshaft; and a driven assembly positioned about the crankshaft between the first side of the housing and the fixed driven sheave, wherein the driven assembly is configured to transmit power from the fixed and moveable driven sheaves to a drive wheel such that the drive wheel rotates slower and with more torque than the fixed and moveable driven sheaves.

The transmission of the sixth aspect may include one or more of the previous embodiments and, optionally, that the driver assembly is positioned in a first sealed portion of the housing configured to receive a lubricant, and the driven assembly is positioned in a second sealed portion of the housing configured to receive a lubricant.

The transmission of the sixth aspect may include one or more of the previous embodiments and, optionally, that the belt has a v-shaped cross-section, and inner surfaces of the fixed and moveable driver sheaves and inner surfaces of the fixed and moveable driven sheaves are tapered to complement side surfaces of the v-shaped belt.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about.”

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. The use of “engaged with” and variations thereof herein is meant to encompass any direct or indirect connections between components.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present disclosure. Moreover, references made herein to “the present invention” or aspects thereof should be understood to mean certain embodiments of the present invention/disclosure and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

It is to be appreciated that any feature or aspect described herein can be claimed in combination with any other feature(s) or aspect(s) as described herein, regardless of whether the features or aspects come from the same described embodiment.

Any one or more aspects described herein can be combined with any other one or more aspects described herein. Any one or more features described herein can be combined with any other one or more features described herein. Any one or more embodiments described herein can be combined with any other one or more embodiments described herein.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments and together with the general description of the invention given above and the detailed description of the drawings given below, serve to explain the principles of the invention.

FIG. 1 is a side elevation view of part of a bicycle with a transmission in accordance with an embodiment of the present disclosure;

FIG. 2A is a side elevation view of the transmission in FIG. 1 in accordance with an embodiment of the present disclosure;

FIG. 2B is a top plan, cross-sectional view of the transmission taken along line A-A in FIG. 2A in accordance with an embodiment of the present disclosure;

FIG. 3A is a perspective view of a first planetary gear set in accordance with an embodiment of the present disclosure;

FIG. 3B is a perspective view of the first planetary gear set in FIG. 3A without a carrier in accordance with an embodiment of the present disclosure;

FIG. 3C is a perspective view of a second planetary gear set in accordance with an embodiment of the present disclosure;

FIG. 4A is a perspective view of part of the transmission in FIG. 1 in a high speed ratio in accordance with an embodiment of the present disclosure;

FIG. 4B is a perspective view of part of the transmission in FIG. 1 in a low speed ratio in accordance with an embodiment of the present disclosure;

FIG. 5 is a perspective view of part of the transmission in FIG. 1 without a belt, a moveable driver sheave, and a fixed driven sheave in accordance with an embodiment of the present disclosure;

FIG. 6 is a perspective view of a position motor, a hub, and a countershaft of the transmission in FIG. 1 in accordance with an embodiment of the present disclosure;

FIG. 7 is a perspective view of a third planetary gear set in accordance with an embodiment of the present disclosure;

FIG. 8 is a perspective view of output gears and a drive wheel in accordance with an embodiment of the present disclosure;

FIG. 9 is a schematic view of a controller and other components in accordance with an embodiment of the present disclosure;

FIG. 10 is a perspective view of a transmission in accordance with an embodiment of the present disclosure;

FIG. 11 is a bottom plan, cross-sectional view of the transmission taken along line B-B in FIG. 10 in accordance with an embodiment of the present disclosure;

FIG. 12 is a perspective view of a driver assembly of the transmission in FIG. 10 in accordance with an embodiment of the present disclosure;

FIG. 13 is a perspective view of a position motor of the transmission in FIG. 10 in accordance with an embodiment of the present disclosure;

FIG. 14 is a perspective view of a fixed driven sheave of the transmission in FIG. 10 in accordance with an embodiment of the present disclosure;

FIG. 15 is a perspective view of the driven assembly of the transmission in FIG. 10 in accordance with an embodiment of the present disclosure;

FIG. 16 is a perspective view of a transmission in accordance with an embodiment of the present disclosure;

FIG. 17 is a is a top plan, cross-sectional view of the transmission taken along line C-C in FIG. 16 in accordance with an embodiment of the present disclosure; and

FIG. 18 is a perspective view of a driven assembly of the transmission of FIG. 16 in accordance with an embodiment of the present disclosure.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.
2 Bicycle
4 Crankshaft
6 Pedal
8 Drive Wheel
10 Chain
12 Rear Hub
14 Rear Wheel
16 Transmission
18 Housing
20 First Portion
22 Second Portion
24 Crank Axis
26 First Planetary Gear Set
28 Second Planetary Gear Set
30 Fixed Driver Sheave
32 Moveable Driver Sheave
34 Bias Member
36 Belt
38 Countershaft
40 Counter Axis
42 Fixed Driven Sheave
44 Moveable Driven Sheave
46 Position Motor
48 Third Planetary Gear Set
50 First Output Gear
52 Second Output Gear
54 First Carrier
56 Ring Gear
58a, 58b First Planetary Gear
58c, 58d First Planetary Gear
60 First Sun Gear
62 Second Carrier
64a, 64b Second Planetary Gear
66 Second Sun Gear
68 Driveshaft
70 Driver Pin
72 Driver Slot
74 Driven Slot
76 Driven Pin
77 Screw
78 Hub
80 Output Shaft
82 Eccentric Cam
84 Recess
86 Third Sun Gear
88a, 88b Third Planetary Gear
90 Third Ring Gear
92 Input
94 Controller
96 Battery
98 Electric Motor
100 Transmission
102 Housing
104 Crankshaft
106 First Portion
107 First Side
108 Second Portion
109 Second Side
110 Crank Axis
112 Intermediate Shaft
114 Intermediate Axis
116 Countershaft
118 Counter Axis
120 Drive Wheel
122 Driver Gear Assembly
124 First Gear
126 Second Gear
128 Third Gear
130 Fourth Gear
132 Fixed Driver Sheave
134 Moveable Driver Sheave
136 Position Motor
140 Hub
142 Output Shaft
144 Eccentric Cam
146 Belt
148 Fixed Driven Sheave
150 Moveable Driven Sheave
152 Bias Member
154 Driven Gear Assembly
156 Sun Gear
158 Planetary Gear
160 Carrier
162 Ring Gear
164 First Sealed Portion
166 Second Sealed Portion
168 Recess
170 Fixed Collar
172 Pin
174 Moveable Collar
176 Slot
177 Slot Axis
178 Transmission
180 Housing
182 Crankshaft
184 Crank Axis
186 Countershaft
188 Counter Axis
190 Drive Wheel
192 Driver Gear Assembly
194 Fixed Driver Sheave
196 Moveable Driver Sheave
198 Bias Member
200 Belt
202 Fixed Driven Sheave
204 Moveable Driven Sheave
206 Position Motor
208 Driven Sprocket Assembly
210 Drive Sprocket
212 Belt
214 Driven Sprocket

### DETAILED DESCRIPTION

Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment since describing every possible embodiment of the transmission would be impractical, if not impossible. Numerous alternative embodiments could be implemented, using either current technology or technology developed after the filing date of this patent, which would still fall within the scope of the claims. Additionally, any combination of features shown in the various figures can be used to create additional embodiments of the present disclosure. Thus, dimensions, aspects, and features of one embodiment of the transmission can be combined with dimensions, aspects, and features of another embodiment of the transmission to create the claimed embodiment.

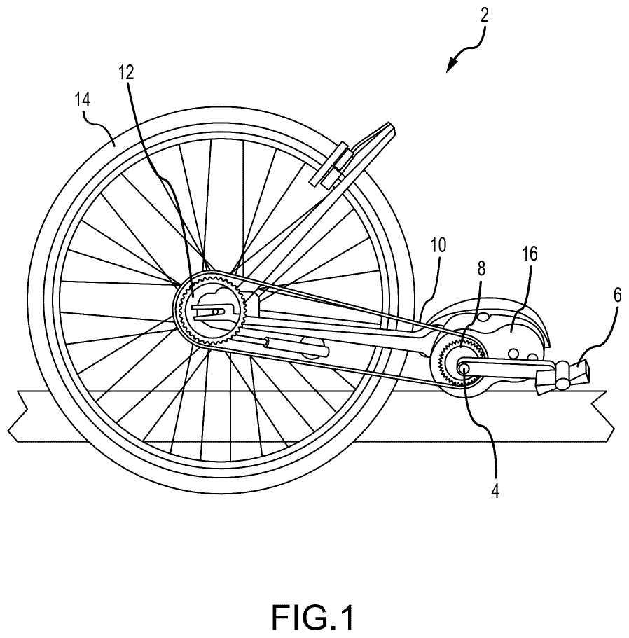

FIG. 1 shows part of a bicycle 2 with a continuously variable transmission 16 of the present disclosure. A user engages pedals 6 to turn a crankshaft 4 and a drive wheel 8, which is a sprocket in this embodiment. Rotation of the drive wheel 8 turns a chain 10 that is engaged with a sprocket of a rear hub 12, and rotation of the rear hub 12 drives a rear wheel 14 to propel the bicycle 2.

In some embodiments, a bicycle 2 will have multiple sprockets at the rear hub 12 and/or at the crankshaft 4, and a gear shifting system moves the chain 10 between these various sprockets to change a gear ratio between the rear hub 12 and the crankshaft 4. The transmission 16 of the present disclosure eliminates the need for multiple sprockets at the rear hub 12 and/or crankshaft 4. However, it will be appreciated that embodiments of the present disclosure can be used in addition to multiple sprockets at the rear hub 12 and/or crankshaft and with a gear shifting system. Moreover, it will be appreciated that embodiments of the present disclosure can be used with electric motors, controllers, and/or batteries that are found on, for instance, e-bikes as well as other components found on bicycles.

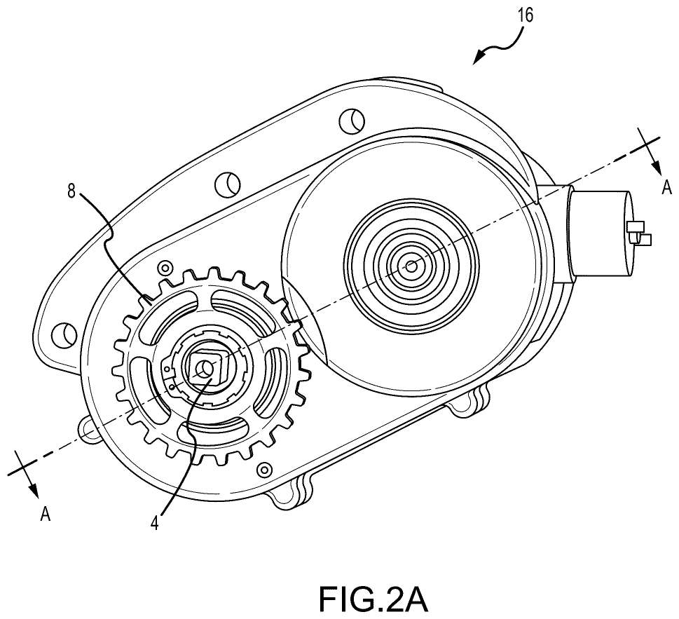

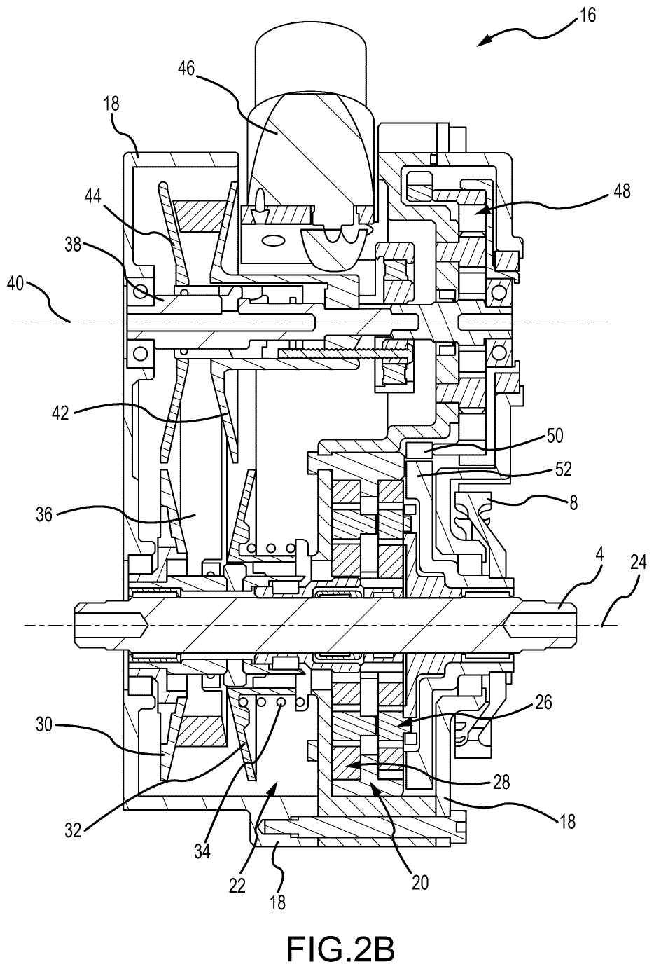

FIG. 2A shows a side elevation view of a continuously variable transmission 16 of the present disclosure. The transmission 16 has a crankshaft 4, a drive wheel 8, and other components described herein to change a speed ratio of the transmission 16 and coordinate an effort on the part of a user with the motion of the bicycle, whether the bicycle is at rest or moving at a particular speed. In various embodiments, a user may choose to customize the bicycle with a choice of, for instance, the crankshaft 4, the drive wheel 8, the pedals, or the crank arms connecting the pedals to the crankshaft 4. Thus, the term “transmission” may include embodiments with or without these components. Also shown in FIG. 2A is line A-A.

FIG. 2B shows a top plan, cross-sectional view of the continuously variable transmission 16 taken along line A-A in FIG. 2A. The crankshaft 4 is rotatable about a crank axis 24, the drive wheel 8 is positioned about the crankshaft 4, and there are several components that link the power applied by a user to the crankshaft 4 and the drive wheel 8 that transmits power to the rear hub to propel the bicycle.

The transmission 16 has a set of driver sheaves 30, 32 that drive a belt 36, which then transmits power to a set of driven sheaves 42, 44. The set of driven sheaves 42, 44 changes and establishes a speed ratio between the sets of sheaves in a continuous manner, and the system of sheaves and the belt 36 works more effectively at higher rotational speed. Specifically, with a higher rotational speed there is less force or torque, which increases the reliability and longevity of components of the transmission 16. Thus, in some embodiments, a driver assembly has an input engaged with the crankshaft 4, and the driver assembly has an output engaged with the driver sheaves 30, 32 that rotates faster and with less torque than the crankshaft. In FIG. 2B, the driver assembly, which can be referred to as a driver gear assembly in this instance, comprises a first planetary gear set 26 and a second planetary gear set 28 where the first planetary gear set 26 has an input engaged with the crankshaft 4 and an output engaged with an input of the second planetary gear set 28. Then, the second planetary gear set 28 has an output engaged with the set of driver sheaves 30, 32.

The transmission 16 is located at the bottom bracket of a bicycle frame, in some embodiments, where the crankshaft 4 extends through the transmission 16. Thus, the driver gear assembly is constrained by its location around the crankshaft 4 and by the distance between crank arms on the crankshaft 4. Moreover, the driver gear assembly is constrained by the overall form factor and housing 18 of the transmission 16 since some components of the bicycle are connected in a certain arrangement, some components maintain a clearance distance over the ground, etc. Thus, a series of two planetary gear sets 26, 28 achieves an overall gear reduction of between approximately 1:12.2 and 1:20.3 to satisfy these constraints. In various embodiments, each planetary gear set 26, 28 has a gear ratio of between approximately 1:3.5 and 1:4.5. In some embodiments, each planetary gear set 26, 28 has a gear ratio of approximately 1:4. In some embodiments, each planetary gear set 26, 28 has the same gear ratio, and in other embodiments, the planetary gear sets 26, 28 have different gear ratios.

It will be appreciated that while two planetary gear sets 26, 28 are depicted in the drawings, the present disclosure encompasses embodiments of the driver gear assembly that have any number of gear sets, gear sets other than planetary gear sets, sprockets, belts, etc. For example, in some embodiments, the driver gear assembly has a single planetary gear set to provide the desired gear ratio or even a system of spur gears. Moreover, it will be appreciated that the gear ratios identified above are exemplary in nature. For example, a single planetary gear set can have a gear ratio between approximately 1:2 to 1:20.

Many of the components of the transmission 16 are disposed within a housing 18, and the housing 18 can have a first portion 20 on a first side and a second portion 22 on a second side. The first and second planetary gear sets 26, 28 are disposed in the first portion 20 of the transmission 16, such that the first portion 20 can be sealed and at least partially filled with a lubricant to promote the operation of the first and second planetary gear sets 26, 28 among other components described herein. The sheaves 30, 32, 42, 44 and the belt 36 are disposed in the second portion 22 that may not be sealed with a lubricant but can still afford the sheaves 30, 32, 42, 44 and the belt 36 protection from the external environment.

The output of the driver gear assembly transmits power to the set of driver sheaves 30, 32. A fixed driver sheave 30 is rotatable about the crank axis 24 but not moveable along the crank axis 24, and the moveable driver sheave 32 is both rotatable about the crank axis 24 and moveable along the crank axis 24. A bias member 34 acts against the moveable driver sheave 32 to bias the moveable driver sheave 32 toward the fixed driver sheave 30. The bias member 34 can have a linear or non-linear response to a force and can be, for instance, a spring. The variable distance between the driver sheaves 30, 32 accommodates different speed ratios established by the set of driven sheaves 42, 44.

The set of driven sheaves 42, 44 comprises a fixed driven sheave 42 that is rotatable about a counter axis 40 of a countershaft 38 but not moveable along the counter axis 40, and a moveable driven sheave 44 that is both rotatable about the counter axis 40 and moveable along the counter axis 40. A position motor 46 controls the position of the moveable driven sheave 44 along the counter axis 40 to establish a speed ratio between the sets of sheaves and, thus, an overall speed ratio—akin to a gear ratio—for the transmission 16. In some embodiments, the position motor 46 is a servo motor that rotates an output shaft, but it will be appreciated that the present disclosure encompasses embodiments where the position motor is another device such as an actuator, etc.

The moveable sheaves 32, 44 are positioned on opposing sides of the belt 36 to help stabilize the belt 36 within the sheaves. Specifically, the moveable driver sheave 32 is positioned between the fixed driver sheave 30 and the driver gear assembly, and the fixed driven sheave 42 is positioned between the moveable driven sheave 44 and the driven gear assembly. It will be appreciated that the present disclosure encompasses embodiments with other arrangements of sheaves.

The set of driven sheaves 42, 44 powers the countershaft 38, which rotates at relatively higher speeds like the sheaves 30, 32, 42, 44 and belt 36 to reduce forces on certain components within the transmission 16. The output of the countershaft 38 is engaged with a driven assembly to decrease speed and increase torque that is more effective for powering the drive wheel 8 and ultimately the rear hub 12 of the rear wheel to propel the bicycle. In this embodiment, the driven assembly, which can be referred to as a driven gear assembly in this instance, is a third planetary gear set 48. The output of the third planetary gear set 48 is engaged with a first output gear 50 that rotates about the counter axis 40. The first output gear 50 is engaged with a second output gear 52 that rotates about the crank axis 24. This second output gear 52 powers the drive wheel 8. In the depicted embodiment, the output gears 50, 52 have a gear ratio that further decreases speed and increases torque.

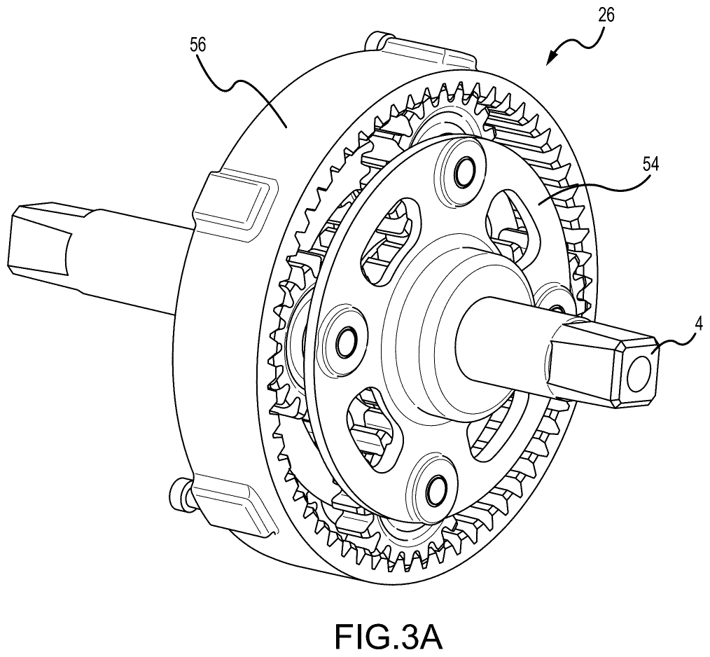

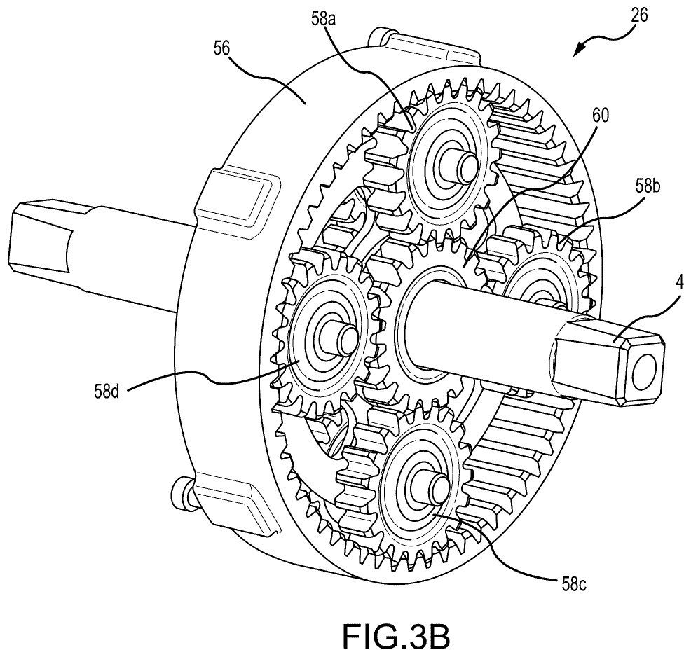

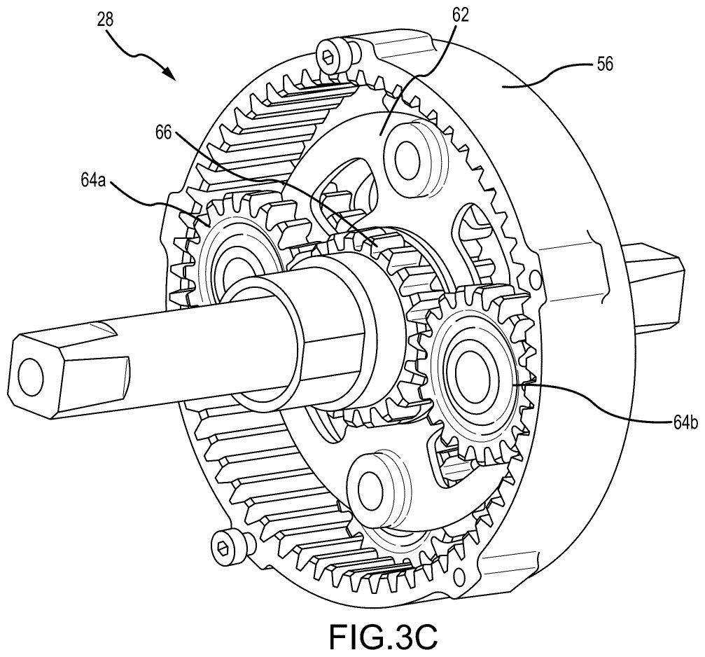

FIGS. 3A and 3B show a first planetary gear set 26. In this embodiment, the crankshaft 4 is connected to a carrier 54 of the first planetary gear set 26. The carrier 54 drives four planetary gears 58a-58d disposed within a ring gear 56. Other embodiments within the scope of the disclosure have more or fewer planetary gears 58a-d. In this embodiment, the ring gear 56 is fixed relative to the housing and does not rotate. The four planetary gears 58a-58d rotate (i.e., drive) a first sun gear 60, which is the output of the first planetary gear set 26. In this embodiment, the gear ratio is 1:4, but it will be appreciated that the present disclosure encompasses any number of gear ratios. Moreover, it will be appreciated that the present disclosure encompasses other arrangements of gears or other components beyond a planetary gear set to increase a rotational speed at an output.

FIG. 3C shows a second planetary gear set 28. The same ring gear 56 from the first planetary gear set 26 operates with components of the second planetary gear set 28. Thus, the terms “first planetary gear set” and “second planetary gear set” can include the same ring gear 56, different parts of the same ring gear 56, or different ring gears 56 in various embodiments. The first sun gear (60 in FIG. 3B) is connected to a second carrier 62 of the second planetary gear set 28. The second carrier 62 drives two planetary gears 64a, 64b, which drive a second sun gear 66 that serves as the output of the second planetary gear set 28. The second planetary gear set 28 and other planetary gear sets described herein can have any number of planetary gears, for instance, two, four, or more planetary gears.

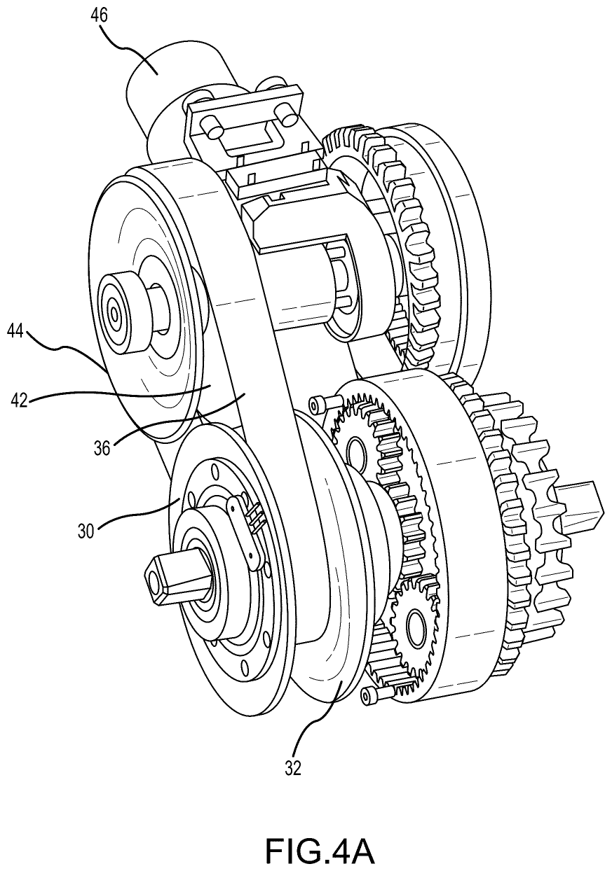

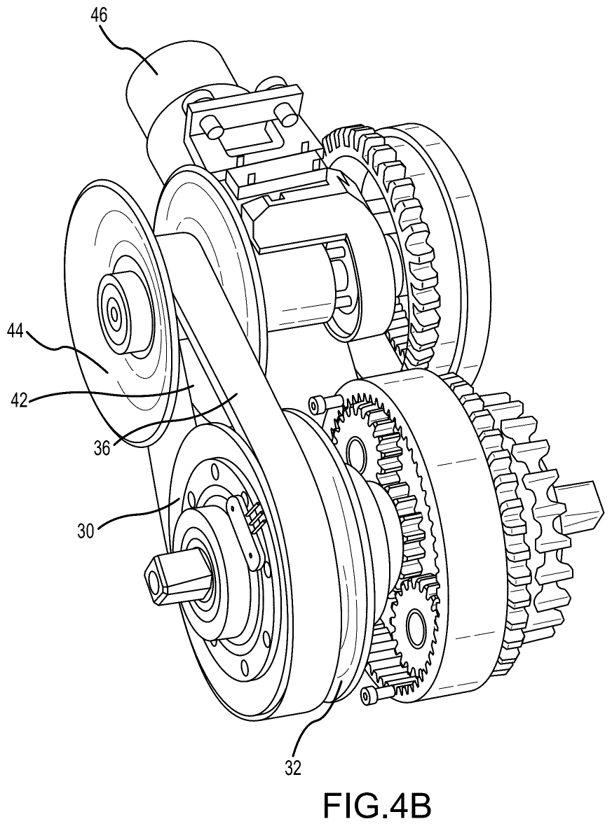

FIGS. 4A and 4B show components of the transmission at a high speed ratio in FIG. 4A and a low speed ratio in FIG. 4B. In FIG. 4A, the position motor 46 has drawn the moveable driven sheave 44 closer to the fixed driven sheave 42, and this relative positioning between driven sheaves 42, 44 squeezes the belt 36 away from the axis of rotation of the driven sheaves 42, 44. As a result, the belt 36 contacts the inner surfaces of the driven sheaves 42, 44 farther away from the axis of rotation of the driven sheaves 42, 44 than in the low speed ratio shown in FIG. 4B and farther away from the axis of rotation than the belt 36 in the driver sheaves 30, 32.

In response to the positioning of the belt 36 at the driven sheaves 42, 44, the belt 36 is pulled inward at the driver sheaves 30, 32 closer to the axis of rotation of the driver sheaves 30, 32. The inward pulling force of the belt 36 overcomes the force provided by the bias member 34 acting on the moveable driver sheave 32, and, therefore, the moveable driver sheave 32 moves farther away (along the crank axis) from the fixed driver sheave 30. As a result, the belt 36 contacts the inner surface of the driver sheaves 30, 32 closer to the axis of rotation of the driver sheaves 30, 32 than in the low speed ratio shown in FIG. 4B and closer to the axis of rotation than the belt 36 in the driven sheaves 42, 44. The speed ratio in FIG. 4A is a higher speed ratio that provides a higher torque and slower rotational speed that is more suitable for a vehicle at rest or lower speeds.

In FIG. 4B, the position motor 46 has pushed the moveable driven sheave 44 farther away from the fixed driven sheave 42, and this relative positioning between driven sheaves 42, 44 allows the belt 36 to move closer to the axis of rotation of the driven sheaves 42, 44. As a result, the belt 36 contacts the inner surfaces of the driven sheaves 42, 44 closer to the axis of rotation of the driven sheaves 42, 44.

In response to the relative positioning of the driven sheaves 42, 44, the force provided by the bias member acting on the moveable driver sheave 32 causes the moveable driver sheave 32 to move closer to the fixed driver sheave 30 and take up any slack in the belt 36 allowed by the relative positioning of the driven sheaves 42, 44. As a result, the belt 36 contacts the inner surface of the driver sheaves 30, 32 farther away from the axis of rotation of the driver sheaves 30, 32. In this sense, the force caused by the bias member, which can be a linear or non-linear response, works in concert with any pulling force from the belt 36 caused by the relative positioning of the driven sheaves 42, 44. The speed ratio in FIG. 4B is a lower speed ratio that provides lower torque and faster rotational speed that is more suitable for a vehicle in motion to achieve higher speeds. As shown in the figures, the belt 36 can have a v-shaped cross-section where the inner and outer surfaces of the belt 36 are substantially parallel to each other, and the side surfaces of the belt 36 are tapered to complement the angled inner surfaces of the sheaves 30, 32, 42, 44.

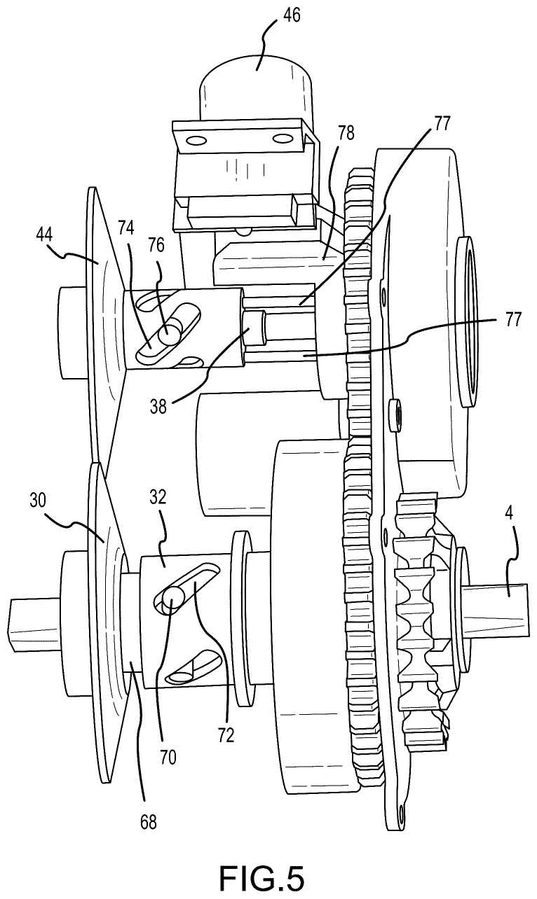

FIG. 5 shows a perspective view of components of the transmission with the removal of the belt, part of the moveable driver sheave 32, and the fixed driven sheave. Starting at the driver side of the transmission, a drive shaft 68 is positioned about the crankshaft 4 and is connected to an output of the driver gear assembly, which in this embodiment is the second sun gear in FIG. 3C. It will be appreciated that in various embodiments, the drive shaft 68 and the second sun gear can be a single component. The drive shaft 68 receives power from the driver gear assembly, and the drive shaft 68 transmits power to the driver sheaves 30, 32. In this embodiment, the drive shaft 68 is directly connected to the fixed driver sheave 30, and the drive shaft 68 is connected to the moveable driver sheave 32 with a pin and slot system. A plurality of pins 70 extend outward from the drive shaft 68 and are positioned in respective slots 72 in a portion of the moveable driver sheave 32. The portion of the moveable driver sheave 32 with the slots 72 may be a cylindrical portion and/or a portion positioned around the crankshaft. In some embodiments, the portion of the moveable driver sheave 32 with the slots 72 is a portion that does not contact the belt 36. Each slot 72 extends along a line that is not parallel to the crank axis. The angle and orientation of the slots 72 balance several functions including effectively transmitting of power from the drive shaft 68 to the moveable driver sheave 32, reducing the force needed to move the moveable driver sheave 32 along the crank axis, and preventing slippage of the belt against the sheaves as the transmission continuously varies between speed ratios.

Similarly, at the driven side of the transmission, pins 76 extend from the countershaft 38 and are positioned in respective slots 74 in a portion of the moveable driven sheave 44. The portion of the moveable driven sheave 44 with the slots 74 may be a cylindrical portion and/or a portion positioned around the countershaft 38. In some embodiments, the portion of the moveable driven sheave 44 with the slots 74 is a portion that does not contact the belt 36. Thus, the moveable driven sheave 44 along with the fixed driven sheave 42 transmit power from the belt to the countershaft 38. In addition, each slot 74 extends along a line that is not parallel to the counter axis. The angle and orientation of the slots 74 also balance several functions including effectively transmitting power from the moveable driven sheave 44 to the countershaft 38, reducing the force needed to move the moveable driven sheave 44 along the counter axis, and preventing slippage of the belt against the sheaves as the transmission continuously varies between speed ratios.

The position motor 46 engages a hub 78 in order to move the moveable driven sheave 44 along the counter axis and establish the speed ratio of the transmission. The hub 78 is offset from the moveable driven sheave 44 along the counter axis, and the hub 78 is connected to the moveable driven sheave 44 with a plurality of bolts 77. This connection provides space for the fixed driven sheave (42 in FIGS. 4A and 4B) to connect to the countershaft 38. While a plurality of bolts 77 is depicted, it will be appreciated that the present disclosure encompasses other embodiments with different connections between the hub 78 and the moveable driven sheave 44, for example, pins or other connection mechanisms.

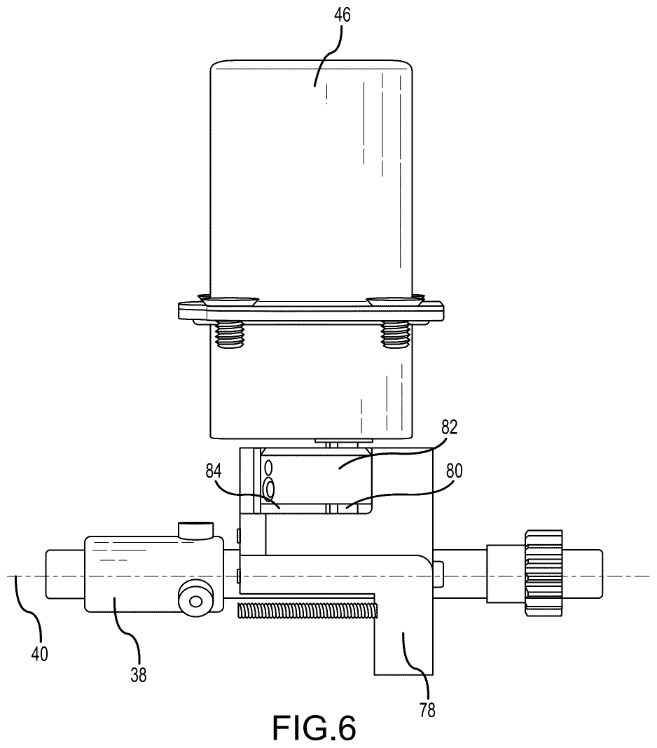

FIG. 6 is a top plan view of the position motor 46, the hub 78, and the moveable driven sheave 44. In this embodiment, the position motor 46 is a servo motor that has an output shaft 80. The position motor 46 can rotate the output shaft 80 about its longitudinal axis in either a clockwise or a counterclockwise direction. An eccentric cam 82 is connected to the output shaft 80 such that rotation of the output shaft 80 also rotates the eccentric cam 82. In one embodiment, the output shaft 80 has a circular cross-section with a flat side and the eccentric cam 82 has a similar shaped hole such that the output shaft 80 fits into the eccentric cam 82 like a key into a keyhole. The keyed connection can be a different shape, for example, a square, a triangle, a hexagon, a circle with indentations and protrusions, etc. The eccentric cam 82 has a generally cylindrical shape and its center axis of the cylindrical shape is offset from the axis of the output shaft 80. In other words, the output shaft 80 does not go through and/or is not concentric with the center point (and center axis) of the eccentric cam 82. Therefore, as the output shaft 80 rotates, the eccentric cam 82 rotates, and the center axis or mass of the eccentric cam 82 moves in a direction parallel to the counter axis 40, or left and right as shown in FIG. 6.

The eccentric cam 82 is positioned in a recess 84 of the hub 78, and the motion of the hub 78 is limited to movement along the counter axis 40. Thus, the movement of the eccentric cam 82 parallel to the counter axis 40 is translated to the hub 78, and the hub 78 moves along the counter axis 40. As the hub 78 moves along the counter axis 40, the moveable driven sheave (44 in FIGS. 4A and 4B) moves along the counter axis 40 in response to the rotation of the output shaft 80 of the position motor 46 because the hub 78 is connected to the moveable driven sheave (44 in FIGS. 4A and 4B). The position motor 46 can rotate the output shaft 80 with certain characteristics such that the moveable driven sheave (44 in FIGS. 4A and 4B) establishes or changes the speed ratio with certain characteristics. The position motor 46 can rotate the output shaft 80 with a predetermined angular speed, angular momentum, and/or angular acceleration. Moreover, the position motor 46 can rotate the output shaft 80 to accommodate a shifting or constantly changing speed ratio, instead of moving between discrete speed ratios.

While the figures show a position motor 46 controls the relative positioning of the driven sheaves, in some embodiments, the position motor 46 controls the relative positioning of the driver sheaves, and the driven sheaves automatically adjust to the speed ratio established by the position motor 46 and the driver sheaves.

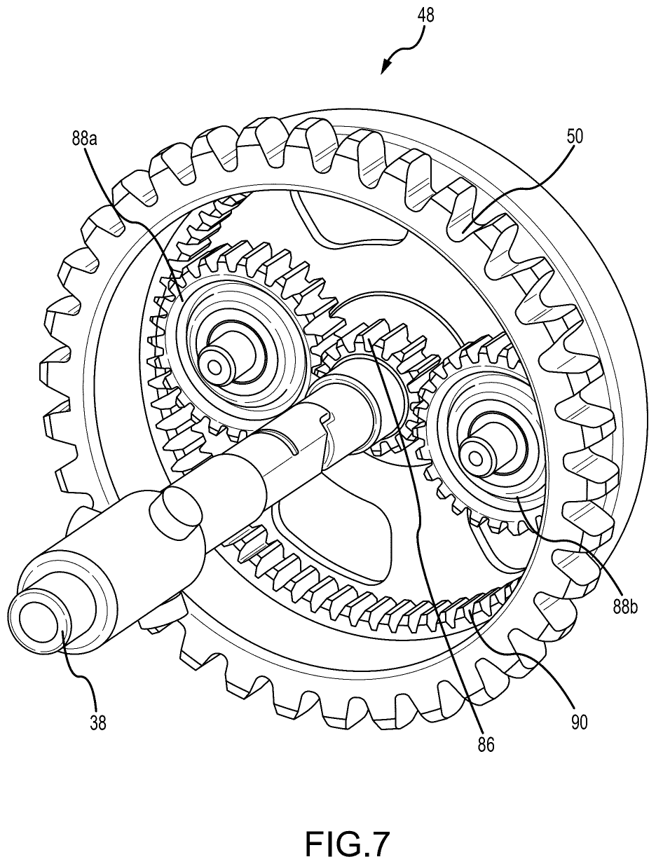

FIG. 7 shows a driven gear assembly, which in this embodiment is a third planetary gear set 48. The countershaft 38 is connected to an input of the third planetary gear set 48, which in this embodiment is a third sun gear 86. It will be appreciated that the countershaft 38 and the third sun gear 86 are depicted as separate components, but the present disclosure encompasses further embodiments, including embodiments where the countershaft 38 and the third sun gear 86 are a single component.

The power transmitted to the third sun gear 86 turns two planetary gears 88a, 88b, which then turn a ring gear 90 such that the ring gear 90 turns slower and with more torque than the countershaft 38 and the third sun gear 86. The ring gear 90 is connected to a first output gear 50 with teeth extending around an outer surface of the first output gear 50. In some embodiments, the ring gear 90 and the first output gear 50 are separate components, and in some embodiments, the ring gear 90 and the first output gear 50 are a single component, which could be described as a ring gear 90 having teeth extending around an inner surface and an outer surface.

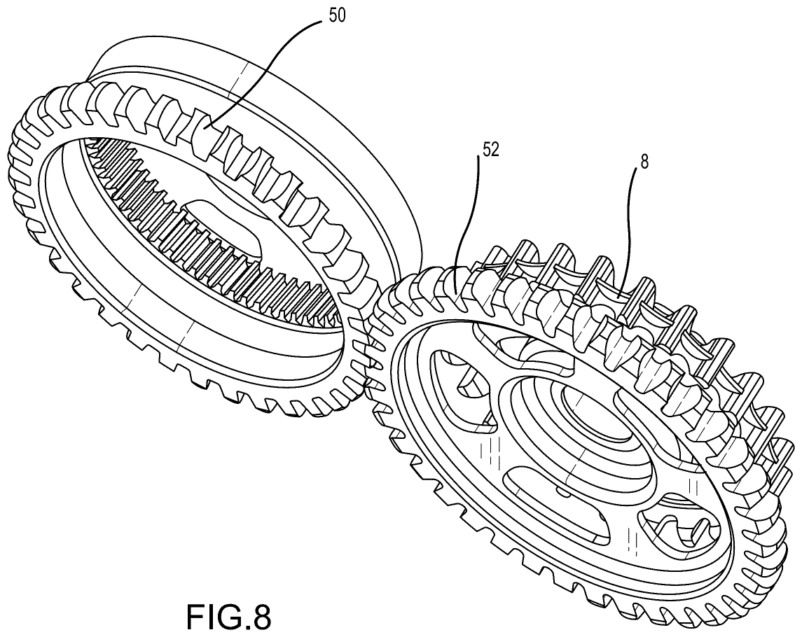

FIG. 8 shows the first output gear 50 connected to a second output gear 52, and the second output gear 52 engaged with the drive wheel 8. Power is transmitted from the first output gear 50 to the second output gear 52, and these gears 50, 52 can have various gear ratios to maintain the same torque and speed, increase the torque while decreasing the speed, or decrease the torque while increasing the speed. Next, the second output gear 52 transmits power to the drive wheel 8. In the depicted embodiment, the drive wheel 8 is affixed to part of the second output gear 52 and secured with a clip. However, it will be appreciated that the present disclosure encompasses embodiments where the drive wheel 8 is affixed to part of the second output gear 52 in another manner and embodiments where the drive wheel 8 and the second output gear 52 are a single component. The second output gear 52 and the drive wheel 8 are positioned about the crankshaft and rotatable about the crank axis as is the typical location for a drive wheel 8 in prior art bicycles. The drive wheel 8 is engaged with a chain to drive a rear hub of a bicycle to propel the bicycle. Alternatively, instead of gears 50, 52 a belt such as a timing belt can transmit power. Additionally or alternatively, instead of the drive wheel and chain, a belt system can be used to drive the rear hub and/or rear bicycle wheel.

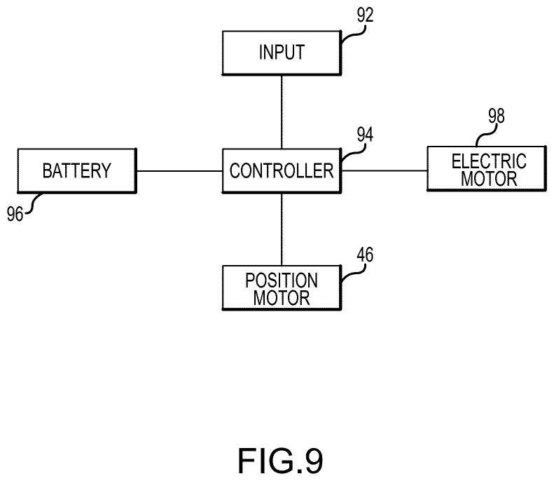

FIG. 9 shows a schematic view of a controller 94 and other components in communication with each other for operation of the transmission. An input 92 can transmit an input signal to the controller 94 where the input signal is analyzed, and depending on the analysis, the controller 94 allows a battery 96 to supply electrical power to the position motor 46 to establish the speed ratio of the transmission.

The input 92 can be a variety of devices, and some embodiments of the disclosure may have multiple inputs 92. In one embodiment, the input 92 is a shifter like a gear shifter on a bicycle. Thus, in various embodiments, a user can move a dial or paddle on an input shifter 92 to select a speed ratio. The physical movement of the dial or paddle is detected by a sensor of the input shifter 92 which sends the input signal to the controller 94. In some embodiments, the user selects among a finite number of speed ratios to keep the system familiar to a user of prior art bicycles. In various embodiments, the user selects among an infinite number of possible speed ratios. The input signal or other signals can be transmitted via a wired connection or a wireless connection.

Based on the input signal, the controller 94 changes the amount of power supplied to the position motor 46 by the battery 96. Moreover, based on the input signal, the controller 94 can concurrently transmit an output signal to the position motor 46 to dictate actions of the position motor 46 such as the direction of rotation of the output shaft, speed and acceleration of the rotation of the output shaft, etc.

Another possible input 92 is a torque sensor, which is engaged with, for example, the crankshaft and the drive wheel, or a component connected to the drive wheel such as the second output gear. When a user applies a force to the pedals and the crankshaft, the crankshaft experiences a torque relative to the drive wheel. In some situations, a user applies less torque or no torque at all when coasting downhill. Conversely, in other situations, a user applies more torque when climbing uphill and the user exerts substantial effort. The torque sensor transmits an input signal to the controller 94, and based on the input signal, the controller 94 can take further action or not. The further action may include changing the amount of power supplied to the position motor 46 by the battery 96 among other actions described herein such as transmitting an output signal to the position motor 46 to, for instance, lower the speed ratio to assist a substantial effort of the user. The torque sensor (input) 92 may also convey information about the speed of rotation of the crankshaft and/or drive wheel. In other embodiments, a separate cadence or speed sensor can serve as another input 92 to the controller 94. The input 92 can be any sensor that detects characteristics of the transmission or environment around the transmission or user input.

Moreover, in various embodiments, the transmission operates in coordination with other components such as an electric motor 98 as is the case in electric bicycles, or e-bikes. Electric motors are used in e-bikes to assist a user in different situations, including pedaling uphill or starting from a rest position. With a similar purpose of assisting the effort of a user, the present disclosure encompasses embodiments where a transmission, as described herein, is combined with an electric motor 98.

In some embodiments, a user input and/or an input from a sensor such as a torque sensor is transmitted to a controller 94 in the form of an input signal. Based on this input signal, the controller 94 directs the position motor 46 of the transmission and/or the electric motor 98 to assist the effort of the user. In some embodiments, this may include changing a speed ratio of the transmission as set by the position motor 46 and having the electric motor generate a torque that helps propel the vehicle. In various embodiments, a generator located at a wheel and/or regenerative braking can charge the battery 96 on the bicycle.

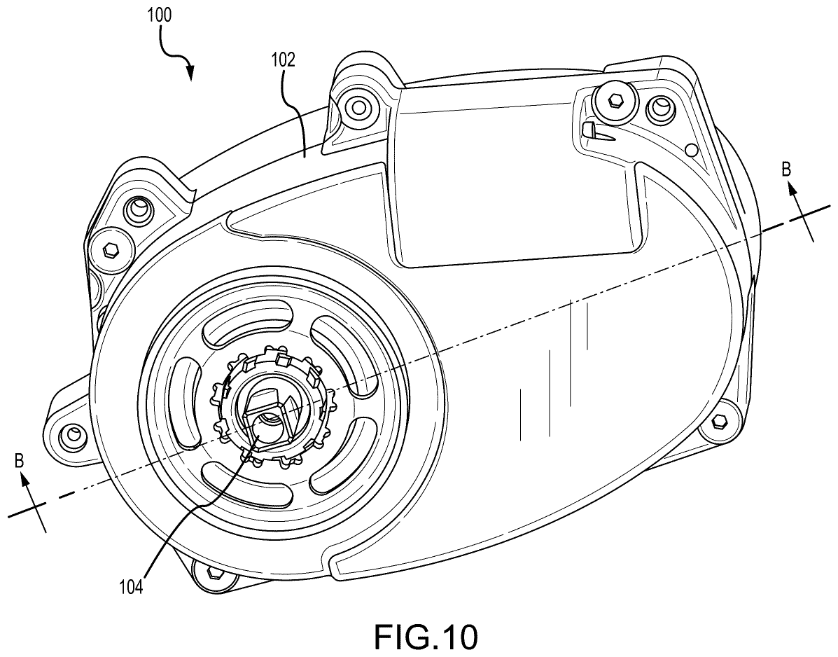

FIG. 10 shows a perspective view of a transmission 100 for a vehicle such as a bicycle. The components of the transmission 100 are mostly contained within a protective housing 102 that prevents dirt and other elements from fouling the components of the transmission 100. A crankshaft 104 extends from the housing 102, and a user turns pedals and crank arms to turn the crankshaft 104, which inputs mechanical power to the transmission 100. Also shown in FIG. 10 is line B-B.

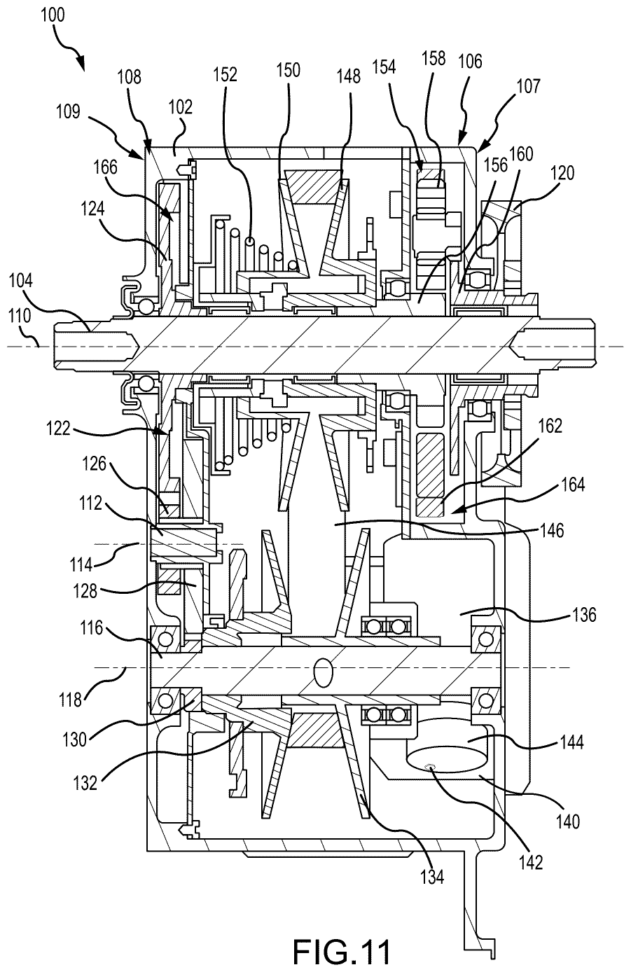

FIG. 11 shows a bottom, cross-sectional view of the transmission 100 taken along line B-B in FIG. 10. The housing 102 comprises a first portion 106 on a first side 107 of the transmission 100 joined to a second portion 108 on a second side 109 of the transmission 100. The terms “first side” and “second side” are relative, and could be used in the reverse or substituted with other relative terms.

The crankshaft 104 is rotatable about a crank axis 110 to provide a mechanical power input to the transmission 100. As the crankshaft 104 turns, power is first transmitted through a driver assembly 122, which can be referred to as a driver gear assembly 122 in this instance, to increase speed and lower torque at the belt 146 of the transmission 100. The increase in speed results in a quicker and more responsive change in speed ratios, and the reduction in torque means less wear on the belt 146 and surrounding components. The driver gear assembly 122 comprises a first gear 124 joined to and positioned about the crankshaft 104. Teeth on an outer surface of the first gear 124 operably engage teeth on an outer surface of a second gear 126, which is joined to and positioned about an intermediate shaft 112. The intermediate shaft 112 is rotatable about an intermediate axis 114. Then, a third gear 128 is joined to and positioned about the intermediate shaft 112. Teeth on an outer surface of the third gear 128 operably engage teeth on an outer surface of a fourth gear 130, which is joined to and positioned about a countershaft 116. The countershaft 116 is rotatable about a counter axis 118.

In this driver gear assembly 122, the second gear 126 has fewer teeth than the first gear 124, the fourth gear 130 has fewer teeth than the third gear 128, and the second and third gears 126, 128 rotate with the intermediate shaft 112. Thus, the driver gear assembly 122 causes the countershaft 116 to rotate with greater speed and less torque than the crankshaft 104. If the overall gear ratio of the driver gear assembly 122 is too low, then the reduction in torque is not enough and the sheaves and belt experience more forces, wear, and tear. If the overall gear ratio is too high, then the components of the transmission 100 can experience excessive speed, which reduces the efficiency of components like bearings and other moving components. Accordingly, in some embodiments, the overall gear ratio of the driver gear assembly 122 is between approximately 1:3.8 to 1:14.5. In various embodiments, the overall gear ratio of the driver gear assembly 122 is approximately 1:9.

It will be appreciated that other driver assemblies 122 can be substituted for the driver gear assembly 122 in FIG. 11. For example, a sequence of planetary gear sets (26, 28 in FIG. 2B) can serve as the driver assembly 122 in FIG. 11. The driver assembly 122 can be positioned in a sealed portion of the housing 102 that contains a lubricant. The terms driver assembly or driven assembly can encompass gear assemblies as well as other assemblies that do not have gears but otherwise change the speed and torque of rotating components.

Next, the countershaft 116 transmits power to a fixed driver sheave 132 and a moveable driver sheave 134 to rotate the belt 146. The fixed driver sheave 132 is rotatable about the counter axis 118 but does not move along the counter axis 118, and the moveable driver sheave 134 is rotatable about the counter axis 118 and is moveable along the counter axis 118. The position of the moveable driver sheave 134 along the counter axis 118 is set by a position motor 136, and the position of the moveable driver sheave 134 along the counter axis 118 sets the speed ratio of the transmission 100. When the distance between the driver sheaves 132, 134 is relatively larger, the belt 146 rides relatively lower in the driver sheaves 132, 134, and the ultimate output of the transmission 100 is more speed and less torque. Conversely, when the distance between the driver sheaves 132, 134 is relatively smaller, the belt 146 rides relatively higher in the driver sheaves 132, 134, and the ultimate output of the transmission 100 is comparatively less speed and more torque.

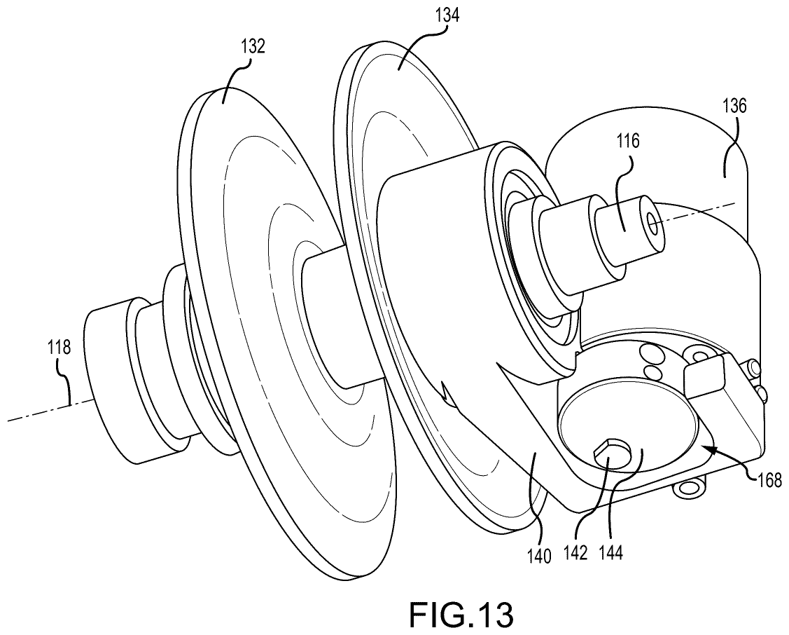

The position motor 136 sets the position of the moveable driver sheave 134 along the counter axis 118 by rotating an output shaft 142, which is set in an eccentric cam 144. In turn, the eccentric cam 144 is set in a recess of a hub 140. As described in further detail with respect to FIG. 13, the eccentric cam 144 and hub 140 translate the rotational motion of the output shaft 142 to linear motion of the moveable driver sheave 134 along the counter axis 118.

At the other end of the belt 146 are a moveable driven sheave 150 and a fixed driven sheave 148 that are positioned about the crankshaft 104 and that receive power from the belt 146. A bias member 152 exerts a force on the moveable driven sheave 150, with a linear or non-linear response, such that the moveable driven sheave 150 can move along the crank axis 110 to accommodate movement of the belt 146 as dictated by the driver sheaves 132, 134 and the position motor 136. The driven sheaves 148, 150 transmit power to a driven assembly 154, which can be referred to as a driven gear assembly 154 in this instance, that steps up torque and reduces speed to a drive wheel 120.

To accommodate the setting of the speed ratio and movement of the belt 146 up and down the sheaves 132, 134, 148, 150, the moveable driver sheave 134 and the moveable driven sheave 150 are positioned on opposing sides of the belt 146. In other words, the moveable driver sheave 134 is between a first side of the housing 102 and the fixed driver sheave 132, and the moveable driven sheave 150 is positioned between a second side of the housing 102 and the fixed driven sheave 148. This arrangement provides stability to the belt 146 while varying speed ratios.

In this embodiment, the driven gear assembly 154 comprises a sun gear 156 that receives power from the driven sheaves 148, 150, a plurality of planetary gears 158 that receives power from the sun gear 156, a ring gear 162 which is fixed and within which the planetary gears 158 rotate, and a carrier 160 that joins the planetary gears 158. The carrier 160 transmits power from the planetary gears 158 to the drive wheel 120. As a whole, the driven gear assembly 154 transmits power to reduce speed and increase torque at the drive wheel 120. In some embodiments, the overall gear ratio of the driven gear assembly 154 is between approximately 3:1 and 4.5:1. In various embodiments, the overall gear ratio of the driven gear assembly 154 is between 3.8:1 and 4:1. The driven assembly 154 can be positioned in a sealed portion of the housing 102 that contains a lubricant. As previously discussed, different driven assemblies can be substituted for one another. Furthermore, a driven assembly is optional where some embodiments of the present disclosure do not include a driven assembly. Instead, the driven sheaves 148, 150 power an output of the transmission 100 that rotates at the same speed and torque as the driven sheaves 148, 150.

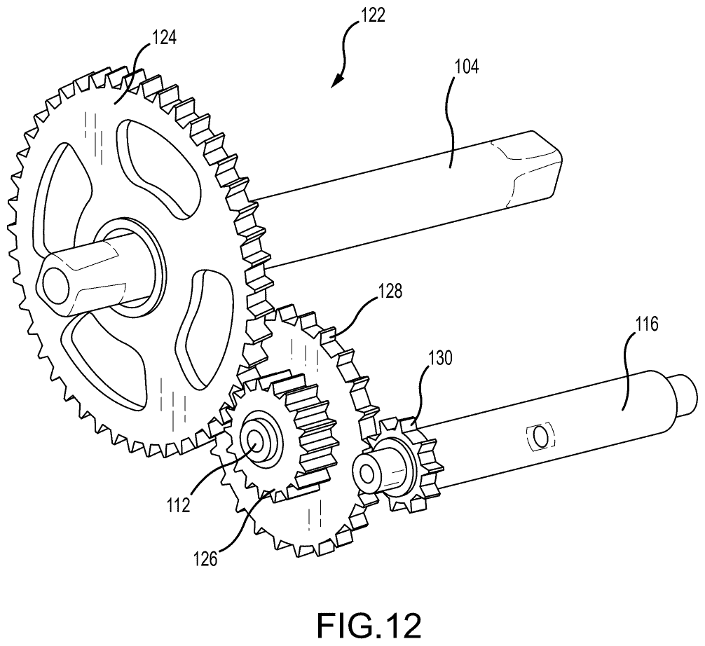

FIG. 12 shows a perspective view of the driver gear assembly 122 in FIG. 11. The first gear 124 transmits power from the crankshaft 104 to the second gear 126 and the intermediate shaft 112. Then, the intermediate shaft 112 and the third gear 128 transmits power to the fourth gear 130 and the countershaft 116. As a result, the countershaft 116 rotates with more speed and less torque than the crankshaft 104.

FIG. 13 shows a perspective view of a position motor 136 and the driver sheaves 132, 134. The output shaft 142 of the position motor 136 is positioned in a cam eccentric 144. In other words, the axis of rotation of the output shaft 142 is offset from a center of the cam eccentric 144. When the position motor 136 receives an input and causes the output shaft 142 and cam eccentric 144 to rotate, the cam eccentric 144 also moves along the counter axis 118 of the countershaft 116. The cam eccentric 144 is positioned in a recess 168 of a hub 140, which is limited to movement along the counter axis 118. Thus, as the cam eccentric 144 moves along the counter axis 118, the hub 140 moves along the counter axis 118, and the moveable driver sheave 134 moves along the counter axis 118 to set the speed ratio of the transmission. The position motor 136 can receive inputs from various components, such as those described with respect to FIG. 9, to rotate the output shaft 142 to different rotational positions at different speeds, accelerations, etc.

The fixed driver sheave 132 can be directly joined to the countershaft 116 to receive power from the countershaft 116. In addition, the countershaft 116 may have outwardly extending pins that extend into slots of the moveable driver sheave 134 like the countershaft (38) and the moveable driven sheave (44) in FIG. 5. Each slot extends along a line that is not parallel to the counter axis 118. The angle and orientation of the slots balance several functions including effectively transmitting power from the countershaft 116 to the moveable driver sheave 134, reducing the force needed to move the moveable driver sheave 134 along the counter axis 118, and preventing slippage of the belt against the sheaves as the transmission continuously varies between speed ratios. Moreover, the position motor 136 is positioned adjacent to the moveable driver sheave 134 which reduces the complexity of the components that translate the movement of the output shaft 142 to the moveable driver sheave 134.

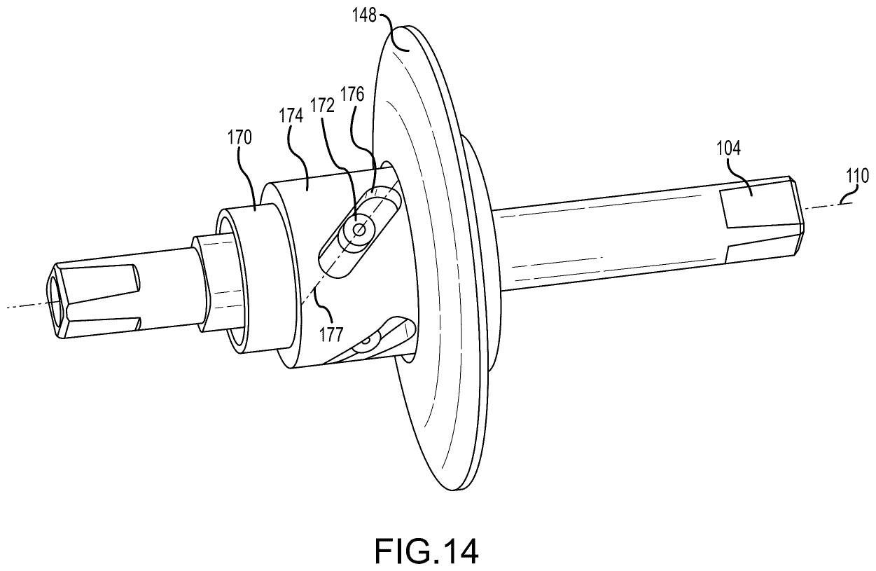

FIG. 14 shows a perspective view of the fixed driven sheave 148, which is rotatable about the crankshaft 104. Here, the moveable driven sheave (150 in FIG. 11) is not shown, but the moveable driven sheave is connected to a moveable collar 174 that has one or more slots 176. The moveable driven sheave and moveable collar 174 may be a single component and/or collectively referred to as the moveable driven sheave. Each slot 176 has an axis 177 that is nonparallel with the crank axis 110. The fixed driven sheave 148 is connected to a fixed collar 170 that has one or more pins 172 that extend outward into corresponding slots 176. The fixed driven sheave 148 and the fixed collar 170 may be a single component and/or collectively referred to as the fixed driven sheave 148. In this embodiment, multiple slots 176 and multiple pins 172 are evenly spaced about the crank axis 110. However, it will be appreciated that the spacing can be uneven, and/or the numbers of slots 176 and pins 172 can be any number.

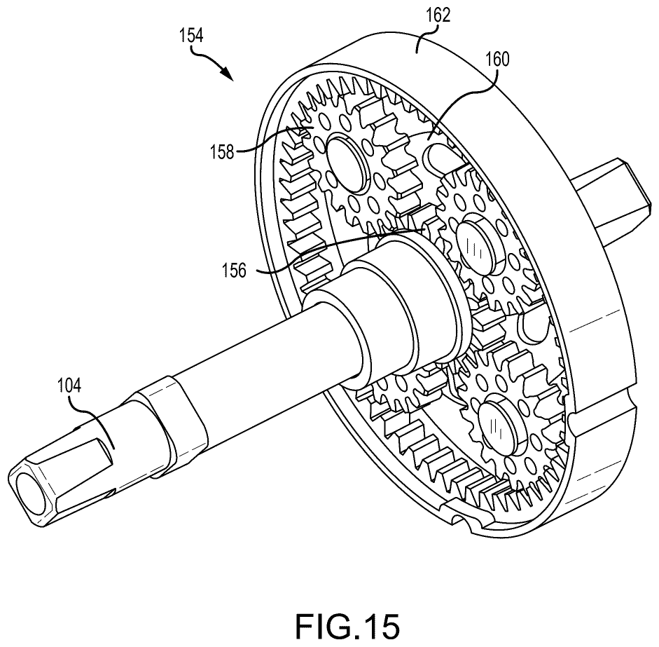

The angle and orientation of the slots 176 balance several functions including effectively transmitting power from the driven sheaves to the driven assembly, reducing the force needed to move the moveable driven sheave along the crank axis 110, and preventing slippage of the belt against the sheaves as the transmission continuously varies between speed ratios. Specifically, the power received by the driven sheaves is transmitted to the collars 170, 174, and the fixed collar 170 transmits power to a sun gear (156 of FIG. 15) of the driven assembly described herein.

The angle that the axis 177 of the slot 176 forms with the crank axis 110 can be between approximately 5 and 50 degrees in some embodiments. In various embodiments, this angle is approximately 20 degrees. The angle between an axis of a slot in the moveable driver sheave 134 and the counter axis 118 can be between approximately 5 and 50 degrees in some embodiments. In various embodiments, this angle is approximately 20 degrees. To support the written description requirement, U.S. patent application Ser. No. 18/126,653 and U.S. patent application Ser. No. 13/328,630 are each incorporated by reference in their entireties.

FIG. 15 shows a perspective view of the driven gear assembly 154 positioned about the crankshaft 104. The sun gear 156 receives power from the driven sheaves, in particular the fixed collar (170 in FIG. 14). Then, the sun gear 156 drives four planetary gears 158 against a stationary ring gear 162. A carrier 160 joins the planetary gears 158 and transmits power to the drive wheel (120 in FIG. 11). The driven gear assembly 154 transmits power to the drive wheel such that the drive wheel rotates with more torque and less speed compared to the driven sheaves. Then, the drive wheel transmits power to, in the instance of a bicycle, a rear hub and a rear wheel.

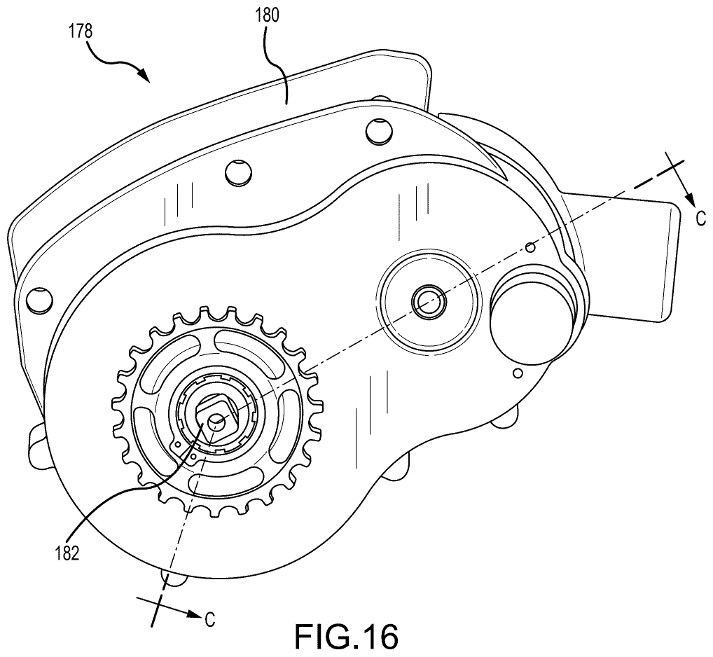

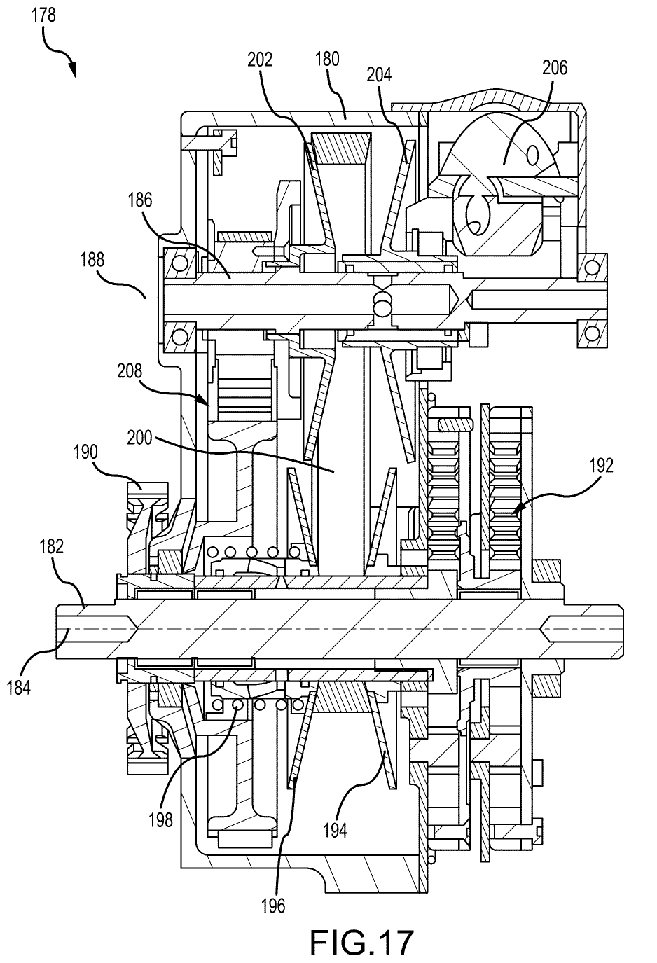

FIG. 16 shows a perspective view of a transmission 178 with a housing 180 where the transmission 178 transmits power for a vehicle such as a bicycle. FIG. 17 shows a cross-sectional view of the transmission 178 in FIG. 16 taken along line C-C. The crankshaft 182 is rotatable about a crank axis 184, and the crankshaft 182 turns a driver assembly 192, which can be referred to as a driver gear assembly 192 in this instance. Specifically, the driver gear assembly 192 is a sequence of planetary gear sets like the transmission in FIG. 2B. The output of the driver gear assembly 192 turns a fixed driver sheave 194 and a moveable driver sheave 196, which is passively biased by a bias member 198, with a linear or non-linear response. The driver sheaves 194, 196 turn a belt 200, which turns a fixed driven sheave 202 and a moveable driven sheave 204. A position motor 206 dictates a position of the moveable driven sheave 204, which sets the speed ratio of the transmission. The driven sheaves 202, 204 turn a countershaft 186 about a counter axis 188. The countershaft 186 turns a driven assembly 208, which can be referred to as a driven sprocket assembly 208 in this instance, that transmits power to a drive wheel 190 and on to, for example, a rear hub and rear wheel of a bicycle.

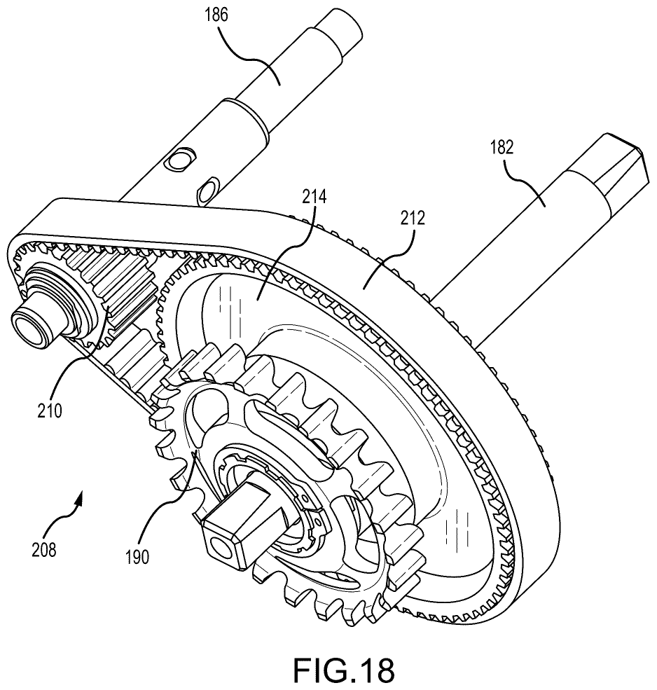

FIG. 18 shows a perspective view of the driven sprocket assembly 208 of the transmission 178 in FIG. 16. The driven sprocket assembly 208 comprises a drive sprocket 210 positioned about the countershaft 186, a driven sprocket 214 positioned about the crankshaft 182, and a synchronous belt 212 that joins the sprockets 210, 214. Thus, the countershaft 186 turns the drive sprocket 210, which turns the belt 212, the driven sprocket 214, and the drive wheel 190. Since the drive sprocket 210 has fewer teeth than the driven sprocket 214, the drive wheel 190 turns with less speed and more torque compared to the countershaft 186. In this embodiment, use of the sprockets 210, 214 and the belt 212 eliminates the need for a sealed portion of the housing that has lubricant in contrast to drive or driven assemblies that have gears engaged with gears.

It will be generally appreciated that various components described herein can be substituted and used in other embodiments described herein without departing from the scope of the present disclosure. For instance, the driven assembly 208 described in FIG. 18 can be used in the transmissions described in FIG. 1 or 10.

While various embodiments of the present disclosure have been described in detail, it is apparent that modifications and alterations of those embodiments will occur to those skilled in the art. However, it is to be expressly understood that such modifications and alterations are within the scope and spirit of the present disclosure, as set forth in the following claims. Further, the invention(s) described herein is capable of other embodiments and of being practiced or of being carried out in various ways. It is to be understood that the phraseology and terminology used herein is for the purpose of description and should not be regarded as limiting.

What is claimed is:

1. A continuously variable transmission for a bicycle, comprising:
a crankshaft rotatable about a crank axis;
a countershaft rotatable about a counter axis;
a driver assembly having an input engaged with the crankshaft and an output engaged with the countershaft, wherein the crankshaft drives the driver assembly, and the driver assembly drives the countershaft such that the countershaft rotates faster and with less torque than the crankshaft;
a set of driver sheaves positioned about the countershaft and engaged with the countershaft;
a set of driven sheaves positioned about the crankshaft;
a belt joining the set of driver sheaves and the set of driven sheaves and configured to transmit power from the set of driver sheaves to the set of driven sheaves, wherein a speed ratio between the sets of driver and driven sheaves is continuously variable; and
a driven assembly positioned about the crankshaft, wherein an input of the driven assembly is engaged with the set of driven sheaves, wherein an output of the driven assembly is configured to rotate slower and with more torque than the set of driven sheaves, and wherein the output of the driven assembly is configured to transmit power to propel the bicycle.

2. The continuously variable transmission of claim 1, further comprising a position motor, wherein the set of driver sheaves comprises:
a fixed sheave; and
a moveable sheave engaged with the position motor, wherein the position motor is configured to move the moveable sheave along the counter axis to change the speed ratio between the sets of driver and driven sheaves.

3. The continuously variable transmission of claim 1, further comprising a bias member, wherein the set of driven sheaves comprises:
a fixed sheave; and
a moveable sheave, wherein the bias member is configured to act on the moveable sheave along the crank axis, and wherein the moveable sheave is configured to change position along the crank axis to accommodate the speed ratio established by the set of driver sheaves.

4. The continuously variable transmission of claim 1, wherein the driver assembly comprises:
a first gear positioned about the crankshaft and that is the input of the driver assembly, and a second gear positioned about and engaged with an intermediate shaft, wherein crankshaft drives the first gear, and the first gear drives the second gear such that the intermediate shaft rotates faster and with less torque than the crankshaft; and
a third gear positioned about and engaged with the intermediate shaft, and a fourth gear positioned about the countershaft and that is the output of the driver assembly, wherein the intermediate shaft drives the third gear, and the third gear drives the fourth gear such that the countershaft rotates faster and with less torque than the intermediate shaft.

5. The continuously variable transmission of claim 4, wherein a gear ratio between the input and output of the driver assembly is between approximately 1:3.8 to 1:14.5.

6. The continuously variable transmission of claim 1, wherein the driven assembly comprises:
a planetary gear set having a ring gear, a plurality of planetary gears, a carrier joining the plurality of planetary gears, and a sun gear, wherein the sun gear is the input for the driven assembly, wherein the sun gear is configured to drive the plurality of planetary gears against the ring gear such that the carrier turns slower and with more torque than the sun gear, and wherein the carrier is the output of the driven assembly.

7. The continuously variable transmission of claim 1, wherein the driven assembly comprises:
a first sprocket that is the input of the driven assembly, and a second sprocket that is the output of the driven assembly; and
a belt joining the first sprocket and the second sprocket.

8. A continuously variable transmission system for a bicycle, comprising:
a crankshaft rotatable about a crank axis;
a countershaft rotatable about a counter axis;
a fixed driver sheave and a moveable driver sheave positioned about the countershaft, wherein the fixed and moveable driver sheaves are configured to receive power from the countershaft;
a fixed driven sheave and a moveable driven sheave positioned about the crankshaft;
a belt joining the fixed and moveable driver sheaves to the fixed and moveable driven sheaves, wherein the belt is configured to transmit power from the fixed and moveable driver sheaves to the fixed and moveable driven sheaves, and wherein a speed ratio between the fixed and moveable driver sheaves and the fixed and moveable driven sheaves is continuously variable;
a bias member configured to act on the moveable driven sheave along the crank axis, wherein the moveable driven sheave changes position along the crank axis to accommodate the speed ratio established by the fixed and moveable driver sheaves; and
a position motor engaged with the moveable driver sheave, wherein the position motor is configured to move the moveable driver sheave along the counter axis to change the speed ratio between the fixed and moveable driver sheaves and the fixed and moveable driven sheaves.

9. The continuously variable transmission system of claim 8, wherein the position motor is a servo motor with an output shaft, and wherein rotation of the output shaft causes the moveable driver sheave to move along the counter axis.

10. The continuously variable transmission system of claim 9, further comprising:
an eccentric cam connected to the output shaft of the servo motor; and
a hub configured to move along the counter axis, wherein the eccentric cam extends into a recess of the hub, and rotation of the output shaft and rotates the eccentric cam and causes the hub to move the moveable driver sheave along the counter axis, which changes the speed ratio between the fixed and moveable driver sheaves and the fixed and moveable driven sheaves.

11. The continuously variable transmission system of claim 8, further comprising:
a controller in communication with the position motor; and
a shifter in communication with the controller, wherein the shifter is configured to transmit an input signal to the controller, and the controller is configured to cause the position motor to move the moveable driver sheave along the counter axis to change the speed ratio between the fixed and moveable driver sheaves and the fixed and moveable driven sheaves.

12. The continuously variable transmission system of claim 8, further comprising:
a controller in communication with the position motor; and
a torque sensor operably engaged with the crankshaft and in communication with the controller, wherein the torque sensor is configured to transmit an input signal to the controller, and the controller is configured to cause the position motor to move the moveable driver sheave along the counter axis to change the speed ratio between the fixed and moveable driver sheaves and the fixed and moveable driven sheaves.

13. The continuously variable transmission system of claim 8, further comprising:
a driver assembly having an input engaged with the crankshaft and an output engaged with the countershaft, wherein the crankshaft drives the driver assembly, and the driver assembly drives the countershaft such that the countershaft rotates faster and with less torque than the crankshaft; and
a driven assembly positioned about the crankshaft, wherein an input of the driven assembly is engaged with the fixed and moveable driven sheaves, wherein an output of the driven assembly is configured to rotate slower and with more torque than the fixed and moveable driven sheaves, and wherein the output of the driven assembly is configured to transmit power to propel the bicycle.

14. The continuously variable transmission system of claim 8, wherein the bias member is a spring producing one of a linearly changing force or a non-linearly changing force in response to displacement.

15. A continuously variable transmission for a bicycle, comprising:
a housing extending from a first side to a second side;
a crankshaft rotatable about a crank axis, wherein the crankshaft is at least partially positioned in the housing;
a countershaft rotatable about a counter axis, wherein the countershaft is positioned in the housing;
a fixed driver sheave and a moveable driver sheave positioned about the countershaft, wherein the fixed and moveable driver sheaves are positioned in the housing, and the moveable driver sheave is positioned between the fixed driver sheave and the first side of the housing, wherein the fixed and moveable driver sheaves are configured to receive power from the countershaft;
a fixed driven sheave and a moveable driven sheave positioned about the crankshaft, wherein the fixed and moveable driven sheaves are positioned in the housing, and the moveable driven sheave is positioned between the fixed driven sheave and the second side of the housing;
a belt configured to transmit power from the fixed and moveable driver sheaves to the fixed and moveable driven sheaves, and wherein a speed ratio between the fixed and moveable driver sheaves and the fixed and moveable driven sheaves is continuously variable; and
a position motor positioned between the moveable driver sheave and the first side of the housing, wherein the position motor is configured to move the moveable driver sheave along the counter axis to change the speed ratio between the fixed and moveable driver sheaves and the fixed and moveable driven sheaves.

16. The continuously variable transmission of claim 15, further comprising:
a bias member configured to act on the moveable driven sheave along the crank axis, wherein the bias member is positioned between the moveable driven sheave and the second side of the housing, and the moveable driven sheave changes position along the crank axis to accommodate the speed ratio established by the fixed and moveable driver sheaves.

17. The continuously variable transmission of claim 15, further comprising:
a fixed collar positioned about the crankshaft, wherein the fixed driven sheave is engaged with the fixed collar;
a moveable collar positioned about the fixed collar, wherein the moveable driven sheave is engaged with a moveable collar;
a plurality of pins extending from the fixed collar into respective slots of the moveable collar such that the moveable collar and the moveable driven sheave are configured to transmit power to the fixed collar and to move along the crank axis.

18. The continuously variable transmission of claim 15, further comprising:
a driver assembly positioned between the second side of the housing and the fixed driver sheave, wherein the driver assembly is configured to transmit power from the crankshaft to the countershaft such that the countershaft rotates faster and with less torque than the crankshaft; and
a driven assembly positioned about the crankshaft between the first side of the housing and the fixed driven sheave, wherein the driven assembly is configured to transmit power from the fixed and moveable driven sheaves to a drive wheel such that the drive wheel rotates slower and with more torque than the fixed and moveable driven sheaves.

19. The continuously variable transmission of claim 18, wherein the driver assembly is positioned in a first sealed portion of the housing configured to receive a lubricant, and the driven assembly is positioned in a second sealed portion of the housing configured to receive a lubricant.

20. The continuously variable transmission of claim 15, wherein the belt has a v-shaped cross-section, and inner surfaces of the fixed and moveable driver sheaves and inner surfaces of the fixed and moveable driven sheaves are tapered to complement side surfaces of the v-shaped belt.
